(19) United States
(12) Patent Application Publication
(10) Pub. No.: US 2025/0390359 A1
(43) Pub. Date: Dec. 25, 2025

(54) AUTOMATIC TILE TENSOR RESHAPING FOR EXECUTION PARALLELIZATION

(71) Applicant: International Business Machines Corporation, Armonk, NY (US)

(72) Inventors: Nir Drucker, Zichron Yaakov (IL); Gilad Ezov, Binyamina (IL); Hayim Shaul, Kfar Saba (IL)

(21) Appl. No.: 18/752,943

(22) Filed: Jun. 25, 2024

(51) Int. Cl. G06F 9/52; H04L 9/00

(52) U.S. Cl. CPC G06F 9/52; H04L 9/008

(57) ABSTRACT

Mechanisms are provided for parallel execution of an application. The application is partitioned into slices. For each slice, a simulation of an execution of the slice with regard to pairings of tile tensor shape for input data to the corresponding slice, and number of available devices to execute the slice, is executed, which generates a plurality of simulation results, each having performance metric(s) for a corresponding pairing. A set of one or more tile tensor shapes for one or more slices in the plurality of slices is generated based on one or more simulation results in the plurality of simulation results. The selected tile tensor shape for each slice is used to pack data for input to a corresponding slice in the one or more slices. Furthermore, the application is executed using the selected set of one or more tile tensor shapes for the one or more slices.

### BACKGROUND

The present application relates generally to an improved data processing apparatus and method and more specifically to an improved computing tool and improved computing tool operations/functionality for automatically reshaping tile tensors for execution parallelization.

A tensor is a mathematical object that describes a multilinear relationship between sets of algebraic objects related to a vector space. Tensors generalize the concept of scalars, vectors, and matrices to higher dimensions. In the context of data science, tensors are multidimensional data structures used to represent and store complex data upon which computations are performed. Machine learning mechanisms, such as TensorFlow® (a trademark of Google, LLC). and PyTorch® (a trademark of the Linux Foundation), utilize tensors to perform machine learning operations and train machine learning computer models, e.g., neural networks.

Tensors have various attributes that describe the tensor including a rank, shape, and data type. Tensors have a “rank” which indicates the number of dimensions represented by the tensor, e.g., rank 1 is a vector tensor, rank 2 is a matrix, etc. The “shape” of a tensor refers to the size of each of the dimensions of the tensor, e.g., a matrix with 4 rows and 4 columns would have a shape of (4, 4). The “data type” of a tensor refers to the types of values stored in the tensor, e.g., int64 or float32.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for parallel execution of an application. The method comprises partitioning the application into a plurality of slices, each slice comprising a portion of the application. The method further comprises, for each slice in the plurality of slices, executing a simulation of an execution of the slice with regard to a plurality of pairings of tile tensor shape for input data to the corresponding slice, and number of available devices to execute the slice, to thereby generate a plurality of simulation results, each having at least one performance metric for a corresponding pairing. In addition, the method comprises selecting a set of one or more tile tensor shapes for one or more slices in the plurality of slices based on one or more simulation results in the plurality of simulation results. The selected tile tensor shape for each corresponding slice is used to pack data for input to the corresponding slice in the one or more slices. Furthermore, the method comprises executing the application using the selected set of one or more tile tensor shapes for the one or more slices.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIGS. 1A and 1B are diagrams illustrating slot-wise operations performed on example ciphertexts in a scheme that supports single-instruction-multiple-data (SIMD);

FIG. 2A is an example diagram illustrating an example single-instruction-multiple-data (SIMD) packing in which a tensor is packed with ciphertexts column-wise;

FIG. 2B is an example diagram illustrating an example single-instruction-multiple-data (SIMD) packing in which a tensor is packed with ciphertexts row-wise;

FIG. 3 is an example plot of the performance of a SIMD homomorphic encryption (HE) operation for various packing methods;

FIG. 4 is an example diagram illustrating different packings of an input tensor into tile tensors having different tile tensor shapes;

FIGS. 5A-5D are example diagrams illustrating how the number of devices and shape of the tile tensor affect parallelization of the execution of operations of a circuit;

FIGS. 6A-6C are example diagrams illustrating an alternative tile tensor shape that provide improved parallelization of execution of the circuit in FIGS. 5A-5D;

FIG. 7 is an example diagram of a distributed data processing system environment in which aspects of the illustrative embodiments may be implemented and at least some of the computer code involved in performing the inventive methods may be executed;

FIG. 8 is an example diagram of the primary operational components of a HE service cloud computing system employing the variable tile tensor shape (VTTS) system in accordance with one illustrative embodiment;

FIGS. 9A and 9B are example diagrams illustrating a shortest path, or lowest latency path, selection using a HE circuit tile tensor shape selection graph in accordance with one illustrative embodiment;

FIG. 10 is a flowchart outlining an example offline operation of a VTTS system in accordance with one illustrative embodiment; and

FIG. 11 is a flowchart outlining an example runtime or online operation of a VTTS system in accordance with one illustrative embodiment.

### DETAILED DESCRIPTION

The illustrative embodiments provide an improved computing tool and improved computing tool operations/functionality for automatically reshaping tile tensors for execution parallelization. The illustrative embodiments are specifically directed to improving the way in which computer operations using tile tensors are performed so as to promote parallelization and thereby improve the speed and efficiency by which such computer operations are performed. The tile tensors are data structures that allow packing of tensor data of arbitrary shapes and sizes into a collection of vectors of fixed size, such as those required in homomorphic encryption (HE) environments. While the illustrative embodiments will be described in the context of HE environments and HE computer operations performed using tile tensors, it should be appreciated that the illustrative embodiments are not limited to HE environments and HE computer operations. To the contrary, the illustrative embodiments are applicable to, and improve the parallelization and speed/efficiency of the performance of any computer operations that utilize tile tensors to perform the computer operations.

The following description provides examples of embodiments of the present disclosure, and variations and substitutions may be made in other embodiments. Several examples will now be provided to further clarify various aspects of the present disclosure.

Example 1: A method, in a data processing system, for parallel execution of an application. The method comprises partitioning the application into a plurality of slices, each slice comprising a portion of the application. The method further comprises, for each slice in the plurality of slices, executing a simulation of an execution of the slice with regard to a plurality of pairings of tile tensor shape for input data to the corresponding slice, and number of available devices to execute the slice, to thereby generate a plurality of simulation results, each having at least one performance metric for a corresponding pairing. The method also comprises selecting a set of one or more tile tensor shapes for one or more slices in the plurality of slices based on one or more simulation results in the plurality of simulation results, wherein the selected tile tensor shape for each corresponding slice is used to pack data for input to the corresponding slice in the one or more slices. In addition, the method comprises executing the application using the selected set of one or more tile tensor shapes for the one or more slices.

The above limitations advantageously enable tile tensor shapes to be selected for individual slices of the application based on simulation of the slices for various pairings of tile tensor shape and numbers of devices available to execute the slices in parallel. As a result, a higher performance parallel execution of the application may be achieved by selecting the optimum tile tensor shapes for each slice.

Example 2: The limitations of any of Examples 1 and 3-10, where the method is executed in an offline phase of operation prior to dynamic execution of the application. The above limitation advantageously enables the selection of tile tensor shapes for the slices of the application prior to execution of the application such that the tile tensor shapes and transitions between tile tensor shapes for optimal execution of the various slices of the application can be determined ahead of time and thereby avoid any performance impact from selection of tile tensor shapes during execution of the application.

Example 3: The limitations of any of Examples 1-2 and 4-10, where the method is executed in an online phase of operation after execution of the application is initiated, and where executing the application using the selected set of one or more tile tensor shapes comprises continuing execution of the application with the selected set of one or more tile tensor shapes for slices in the plurality of slices that have not already been executed. The above limitation advantageously enables dynamic modification of the selection of the tile tensor shapes. This allows for adaptation of the tile tensor selection dynamically as the runtime execution environment changes, e.g., a number of available devices for parallel execution changes.

Example 4: The limitations of any of Examples 1-3 and 5-10, where the application is a homomorphic encryption (HE) application represented as a HE circuit, the data is a workload of ciphertexts, and the slices are sub-circuits of the HE circuit. The above limitations advantageously enable the selection of tile tensor shapes for slices of an HE application based on number of available devices and the particular ciphertexts involved so as to achieve optimal performance of the execution of the HE application in a parallel manner.

Example 5: The limitations of any of Examples 1-4 and 6-10, where selecting a set of one or more tile tensor shapes comprises generating a graph representation data structure of the application in which the graph representation data structure represents the plurality of slices in planes corresponding to different tile tensor shapes, each plane having one or more sub-planes corresponding to numbers of available devices, nodes of each plane corresponding to a slice in the plurality of slices, and edges representing transitions from one tile tensor shape to another. The above limitations advantageously enable the representation of the various pairings of slices with tile tensor shapes and numbers of available devices so as to consider all the simulation results when selecting the appropriate tile tensor shape to be used with each slice of the application.

Example 6: The limitations of any of Examples 1-5 and 7-10, where selecting the set of one or more tile tensor shapes comprises selecting one or more tile tensor shapes that result in a highest performance path through the graph representation data structure. The above limitations advantageously enable a path selection algorithm to be used to select the optimal combination of tile tensor shapes for slices of the application that provides the highest performance and thus, the relatively best option for parallel execution of the application.

Example 7: The limitations of any of Examples 1-6 and 8-10, where the highest performance path is a path having a lowest latency determined based on the plurality of simulation results. The above limitation advantageously enables the selection of the particular set of tile tensor shapes for the slices of the application that provides a lowest latency execution of the application.

Example 8: The limitations of any of Examples 1-7 and 9-10, where the graph representation data structure further comprises one or more reshape operation nodes representing one or more corresponding reshape operations for the transitions from one tile tensor shape to another, where the one or more reshape operation nodes comprise performance metric information for performing the one or more corresponding reshape operations. The above limitations advantageously allow for taking into consideration the performance impact that may result from changing from one tile tensor shape to another between slices of the application. Thus, in some situations, it may be more beneficial to keep the same tile tensor shape rather than transition to a different one, as the overall performance may be better than if one were to implement a reshaping operation to change tile tensor shapes.

Example 9: The limitations of any of Examples 1-8 and 10 where the slices in the plurality of slices have a sequential order, and wherein the selecting of the set of one or more tile tensor shapes is performed dynamically after execution of each intermediate slice in the plurality of slices, wherein the set of one or more tile tensor shapes are used to execute at least a next slice in the plurality of slices. The above limitations advantageously enable the dynamic selection of tile tensor shapes as the application is executing, such as on a slice-by-slice basis.

Example 10: The limitations of any of Examples 1-9, where executing the simulation and selecting the set of one or more tile tensor shapes is performed statically for a first portion of slices in the plurality of slices, and is performed dynamically during execution of the application for a second portion of slices in the plurality of slices. The above limitations advantageously enable both a static analysis to select the tile tensor shape for a first portion of the application, e.g., the first slice or the first few slices, and then dynamically select the tile tensor shapes for a second portion of the application, such as each subsequent slice thereby achieving the benefits of optimization of the first portion's tile tensor shape and the dynamic optimization of the second portion's tile tensor shape. This will provide the overall optimum parallel execution of the entire application.

Example 11: A system comprising one or more processors and one or more computer-readable storage media collectively storing program instructions which, when executed by the one or more processors, are configured to cause the one or more processors to perform a method according to any one of Examples 1-10. The above limitations advantageously enable a system comprising one or more processors to perform and realize the advantages described with respect to Examples 1-10.

Example 12: A computer program product comprising one or more computer readable storage media, and program instructions collectively stored on the one or more computer readable storage media, the program instructions comprising instructions configured to cause one or more processors to perform a method according to any one of Examples 1-10. The above limitations advantageously enable a computer program product having program instructions configured to cause one or more processors to perform and realize the advantages described with respect to Examples 1-10.

As noted above, the illustrative embodiments will be described with regard to example embodiments in which homomorphic encryption computer operations are performed by the mechanisms of the illustrative embodiments. Thus, it is first helpful to understand what a homomorphic encryption (HE) scheme entails. A HE scheme is a cryptographic system that allows its users, e.g., clients, to evaluate any circuit on encrypted data using the following four methods: Gen, Enc, Dec, Eval. The “circuit” is the group of computations or calculations that are to be performed on the encrypted data using HE. That is, for example, one may want to perform a particular operation on input data, where this operation may require a plurality of HE computations to be performed in series and/or parallel to ultimately generate one or more results corresponding to the requested operation. These HE computations may be represented as a graph of nodes and edges proceeding from inputs to one or more outputs with intermediate nodes and intermediate ciphertexts being generated as a result of the HE computations performed at the various stages along the graph. For example, edges in a graph may represent HE computations and nodes in the graph may represent ciphertexts. The combination of these nodes and edges may be considered a “circuit” that defines the various HE input ciphertext(s), the intermediate ciphertext(s), and the output ciphertext(s). These combinations of HE compute operations and resulting ciphertext(s) are referred to as a circuit as the operations of a circuit are not dependent on the particular inputs, e.g., there are no conditional operations, as the inputs are encrypted, and are performed on the inputs to the circuit, similar to classic electrical circuits.

With an HE scheme, a client, e.g., a user of a computing device, a computing process executing on a computing device, or the like (hereafter simply a “client”), can use the key generation method (Gen) to generate a pair of secret and public keys (sk, pk), where the “client” is a client to a HE service provider that provides an HE service, such as a cloud computing HE service or the like, via one or more computing systems, e.g., servers. The client stores the secret key (sk) and publishes the public key (pk).

Using the public key (pk), an untrusted entity can encrypt sensitive data (or a “message”) m; by calling the encryption method (Enc), e.g., cᵢ=Enc_pk(mᵢ). Subsequently, the client can ask the untrusted entity to execute the function c_res=Eval_pk(f,(c₁, . . . , cₙ)) in order to evaluate a function f on some ciphertexts cᵢ and store the results in another results ciphertext c_res. To decrypt c_res using the secret key (sk), the client calls the decryption method (Dec), e.g., m_res=Dec_sk(c_res), where m_res is the resulting decrypted message corresponding to the ciphertext c_res which has been decrypted using the secret key (sk). A HE scheme is correct when m=Dec(Enc(m)) and is approximately correct when m=Dec(Enc(m))+epsilon, for some relatively small epsilon. The “Eval” receives an HE circuit and ciphertext(s) and evaluates the circuit with the given ciphertext(s) as inputs as to whether they are correct or not.

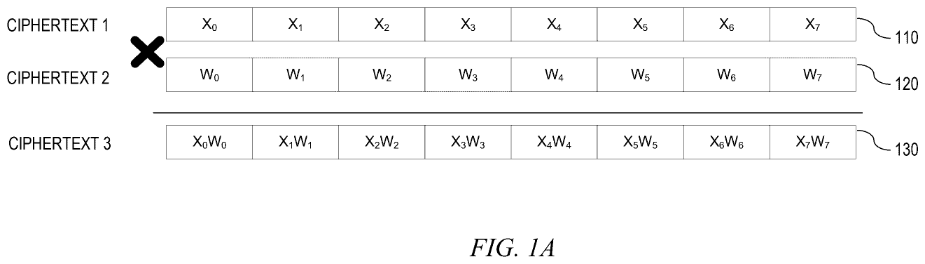

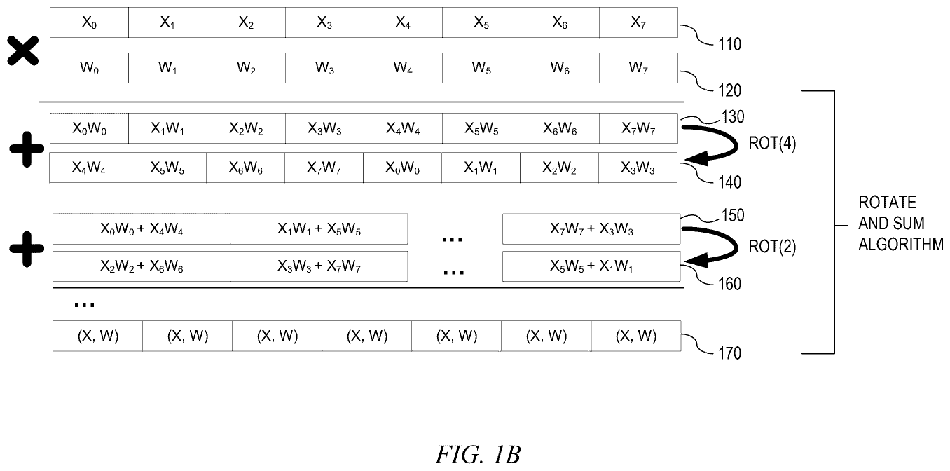

Some HE schemes operate on ciphertexts in a homomorphic single instruction multiple data (SIMD) fashion. This means that a single ciphertext encrypts a fixed-size vector, and the homomorphic operations on the ciphertext are performed slot-wise on the elements of the plaintext vector, where “slot-wise” refers to each of the vector slots of the vector and means that the operations are performed on a vector slot by vector slot basis. For example, as shown in FIG. 1A, a first ciphertext 110 may be packed with a first vector of elements in one ciphertext, i.e., x0 to x7, where each element is in a vector slot. Similarly, a second ciphertext 120 may be packed with a second vector of elements in one ciphertext, i.e., w0 to w7. In the context of an HE operation, these elements are encrypted data. Addition and multiplication operations, for example, may then be performed on these ciphertext in a slot-wise manner so as to generate a result ciphertext 130, in which each vector slot of the ciphertext 130 comprises the product or sum of the corresponding vector slots of the first and second ciphertexts 110-120.

Other operations may be achieved by a combination of multiplication and addition operations with some rotation operations. Rotation operations rotate the vector slots by a specified number of vector slots, wrapping at the ends of the vectors. FIG. 1B illustrates a rotate and sum algorithm that is performed on the result vector 130 generated from the multiplication of the first and second ciphertexts (or vectors) 110-120. An operation such as that shown in FIG. 1B, may be used, for example, to obtain an inner product of the two ciphertexts 110-120. As shown in FIG. 1B, after obtaining the result ciphertext (or vector) 130 in the manner shown in FIG. 1A, a rotation of 4 slots, i.e., Rot(4), to obtain the rotated ciphertext 140 which is then added to the result ciphertext 130. Thereafter, a rotation operation of 2 slots is performed on the result ciphertext 150 is performed to generate the rotated ciphertext 160 which is then added to the result ciphertext 150. These are referred to as rotate and sum (RaS) algorithms, and will ultimately result in an output ciphertext 170 which may represent, for example, an inner product of the original input ciphertexts 110-120.

As is shown in the examples of FIGS. 1A-1B, in order to fully utilize the performance improvements obtainable from SIMD execution, the ciphertexts should be packed and encrypted such that more than one input element is present in every ciphertext and thus, multiple parallel executions on different vector slots may be performed. However, the packing method can dramatically affect the latency (i.e., time to perform computation), throughput (i.e., number of computations performed in a unit of time), communication costs, and memory requirements in order to perform the HE SIMD operation.

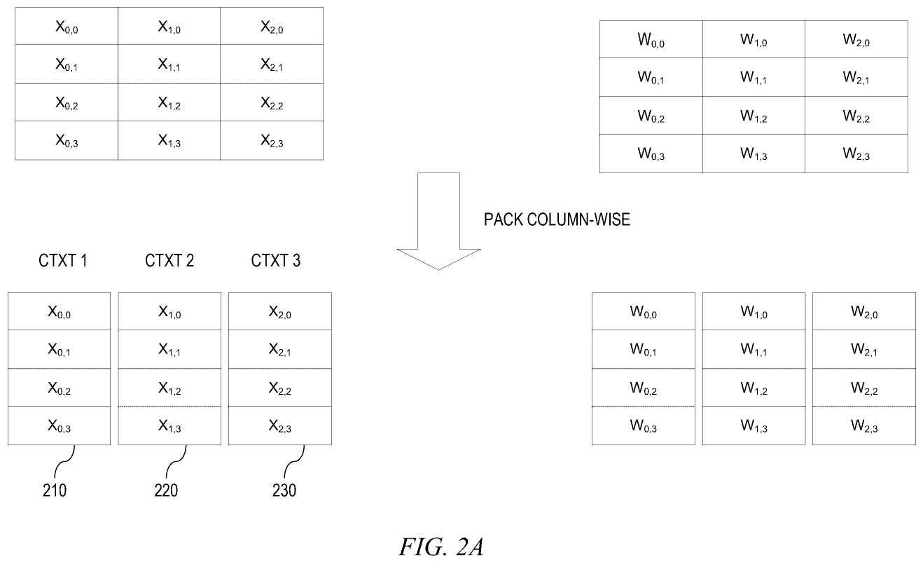

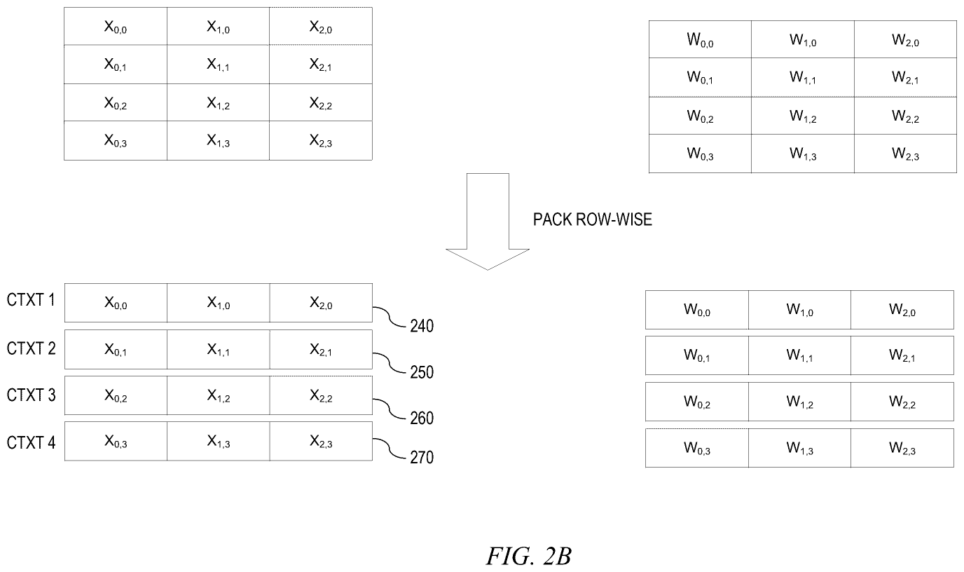

For example, FIG. 2A shows an example SIMD packing in which a tensor is packed with ciphertexts column-wise, e.g., each two dimensional matrix tensor may have each column correspond to a different input vector, e.g., ciphertext 1 210 having encrypted data elements x_{0,0} to x_{0,3}, ciphertext 2 220 having encrypted data elements x_{1,0} to x_{1,3}, and ciphertext 3 230 having encrypted data elements x_{2,0} to x_{2,3} in this example. As shown in FIG. 2B, the SIMD packing may also be performed row-wise, e.g., each two dimensional matrix tensor may have each row correspond to a ciphertext of particular data elements from vector slots of the input ciphertexts. For example, as shown in FIG. 2B, ciphertext 1 240 may comprise the first encrypted data element from each of the input ciphertexts, e.g., x_{0,0}, x_{1,0}, and x_{2,0}. A second ciphertext 2 250 may comprise the second encrypted data element from each of the input ciphertexts, e.g., x_{0,1}, x_{1,1}, and x_{2,1}. This continues with the third and fourth ciphertexts 260, 270.

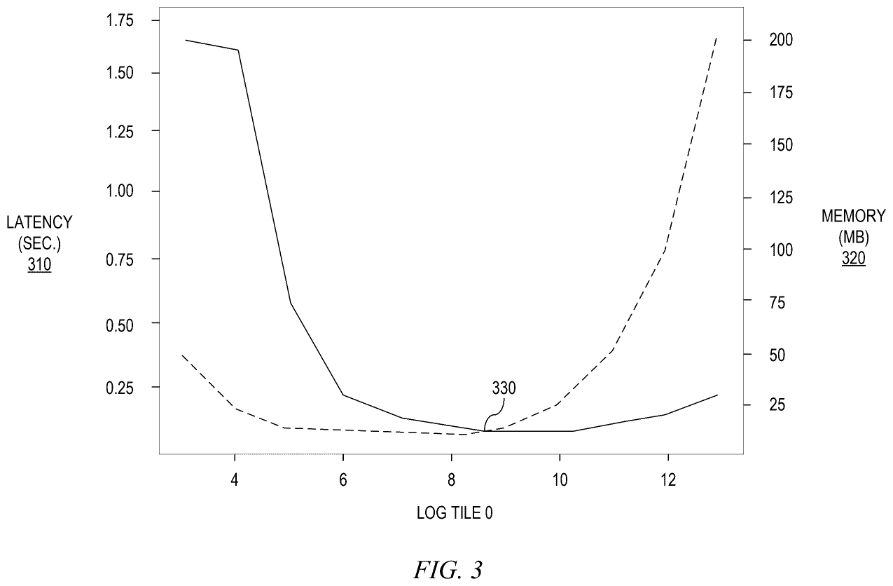

These two packing methods, i.e., column-wise and row-wise, represent the two extremes for packing a matrix tensor for SIMD HE operations. Other types of SIMD packing may also be possible with differing levels of performance, such as with regard to latency of the SIMD HE operation and memory utilization. For example, as shown in FIG. 3, if one plots the performance of the SIMD HE operation for various packing methods, one gets a graph as shown in FIG. 3 where the vertical axis represents latency and memory usage, and the horizonal axis represents different types of packing. As can be seen from FIG. 3, for a given SIMD HE operation, there is a point 330 where latency 310 and memory usage 320 intersect at a low point such that the particular packing at that point represents the optimum packing for achieving a low latency and low memory usage solution. Thus, one can fix a metric, e.g., an amount of memory or a tolerable latency, and a corresponding packing may be selected that achieves an optimum other metric, e.g., fixing an amount of available memory and selecting a packing that gives a lowest latency or fixing the tolerable latency and selecting a packing that requires the smallest amount of memory.

Thus, the particular packing methodology used can greatly impact performance of the SIMD HE operation. That is, if the data is not packed appropriately into the ciphertexts, or vectors of encrypted data, as described hereafter, then data movements between compute devices will be needed, which increases latency and memory utilization, and will impact performance overall.

As noted above, tile tensors are a data structure that makes packing easier. Tile tensors are a data structure that allows clients to store tensors with arbitrary sizes and shapes. The tile tensor packs tensor data into a collection of vectors of fixed size and a set of operators are defined for manipulating the tensor in its packed form. Tile tensors may be used to provide homomorphic encryption (HE) environments where the data values stored in the tensors may be encrypted data values and the tile tensor operators permit the performance of HE operations on such encrypted data.

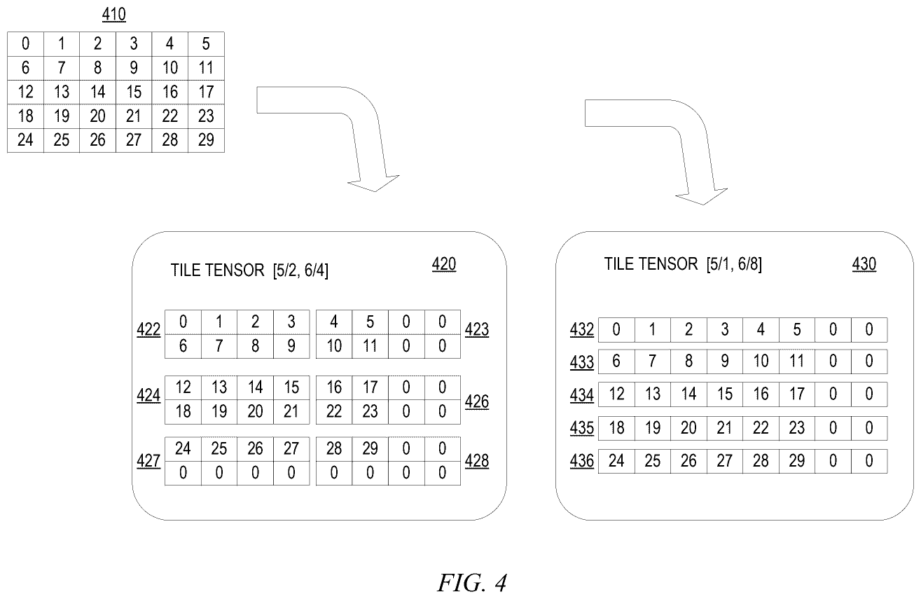

The shape of the tile tensor results in different packings. For example, as shown in the depiction of FIG. 4, the same tensor 410 may be packed differently into two different tile tensor shapes 420 and 430. For example, as shown in FIG. 4, the original tensor 410 is a 5×6 matrix of encrypted data elements 0 through 29. If one is to pack these data elements into a tile tensor 420, where each tile in the tile tensor 420 has a size of 2×4 (2 rows and 4 columns), then portions of each row of the original tensor 410 will need to be in separate tiles and the last row will only partially fill their respective tiles. A tile tensor's shape is represented by a tuple of fractional values, e.g., [5/2, 6/4] for tile tensor 420 or [5/1, 6/8]. The numerator in the fractional values represents the size of the input tensor 410, i.e., 5×6 in this example. The denominator in the fractional values represents the number of vector slots of the tensors of the tile tensor, i.e., 2×4 for tile tensor 420 and 1×8 for tile tensor 430 in this example. Tiles that are not completely filled with data elements from the input tensor 410 are padded with null values as shown in FIG. 4. It should be appreciated that the dimensions of the tile tensors 420 and 430 overall are 6×8 for tile tensor 420 and 5×8 for tile tensor 430.

Thus, if one is to use the tile tensor 420, due to the shape (2×4) of the tensors in the tile tensor 420, the rows of the input tensor 410 extend from one tile tensor 422 to another 423, 424 to 426, and 427 to 428, with appropriate padding with null values. Alternatively, if packing the data elements from 410 into a tile tensor 430, due to its shape (1×8), each row may be packed into a separate tensor 432-436. If one considers that in a SIMD HE operation, different portions of the tile tensors 420, 430 are processed by different devices, depending on the particular number of devices available, different packings will result in more or less efficient performance, depending on the level of parallelization achievable, as discussed in greater detail hereafter.

Thus, packing a matrix m₁ using tile tensors can be done using two-dimensional (2D) or three-dimensional (3D) tile tensors (where in the 3D tile tensors, a matrix is duplicated along one of the dimensions), depending on the context. When the goal is to multiply the matrix m₁ by a vector v, 2D tile tensor objects may be used for m₁ and v. However, if the goal is to multiply the matrix m₁ by another matrix m₂, 3D tile tensor objects should be utilized. Thus, depending on the particular compute operation that is to be performed, different shapes of tile tensors may be utilized more efficiently.

That is, with tile tensors, it is possible to pack the vector v and matrices m₁ and m₂ using different representations, i.e., tile tensor shapes, that depend on the context. For example, the vector v may be packed either in the first dimension of the tile tensor and duplicated over its second dimension, or vice versa. The matrices m₁ and m₂ may be packed over two of the three dimensions of a 3D tile tensor and the third dimension may be used for broadcasting the matrix, where broadcasting is a technique for replicating a smaller array across a larger array in order to make compatible size arrays for element-wise operations, such as “slot-wise” multiplication and addition operations. Note that it is possible to pack a matrix “as-is” or in a transposed manner. It should also be appreciated that while the present description will reference matrices, the illustrative embodiments are applicable to any type of array of various dimensions and is not limited to two-dimensional matrices or vectors.

A HE layers optimizer may be used to automatically choose a shape for all tile tensors, and the rest of the tile tensor based computations are defined accordingly based on this selected shape, i.e., the shape is fixed by the HE layers optimizer and the computations are then defined for this selected shape. One reason for a priori shape selection and subsequent definition of the computations is that reshaping the tile tensor for various computation operations is a costly operation in terms of resource usage and performance of the HE system. Another reason is that checking different shapes at different points of the circuit, e.g., by brute forcing all possibilities, can be inefficient. However, this fixed shape selection does not allow for dynamic changing of the shape to facilitate efficient parallelization of the various individual HE operations of the circuit, i.e., one shape may be efficient for a first HE operation, but less efficient for the next HE operation. Moreover, this fixed shape selection requires that the circuit code be adapted to the selected shape rather than having the shape adapted for the more efficient execution of the HE operations.

Even if the HE layers optimizer is enhanced to automatically choose places in the evaluated HE circuit to perform a reshape operation, the HE layers optimizer still only chooses one fixed shape option for all the tile tensors for subsequent HE operations in the circuit until a next reshape operation is performed, which does not allow the underlying circuit evaluation layer (CircLayer) to leverage dynamically the full power of the computer resources, e.g., processors, memory, graphics processing units (GPUs), and the like, allocated for the process. The reason is that the CircLayer gets as input a given circuit with addition, multiplication, and rotation operations (or gates), and it does not have the knowledge at the level of the tile tensors to perform reshape operations based on the available hardware.

Furthermore, the availability of computer hardware may fluctuate over time based on a variety of different factors. For example, in load balancing approaches, different processors, GPUs, memory, and the like may be allocated to different processes based on load balancing operations. Moreover, in a cloud services environment, different numbers of processors, GPUs, amounts of memory, and the like, may be allocated to different clients and at different times based on utilization, availability, criticality of workloads, or any of a number of different factors. Thus, the dynamic nature of the availability of computer resources makes different levels of parallelization of computer operations achievable. As the number of available processors, GPUs, or the like (referred to herein as “devices”) changes, and thus the number of available devices for performing parallel executions changes, such as in the case of SIMD operations, different shapes of tile tensors may be more or less efficient for performing such operations. However, as mentioned above, the CircLayer does not have the knowledge for performing a reshaping of the tile tensors based on the dynamically changing availability of devices.

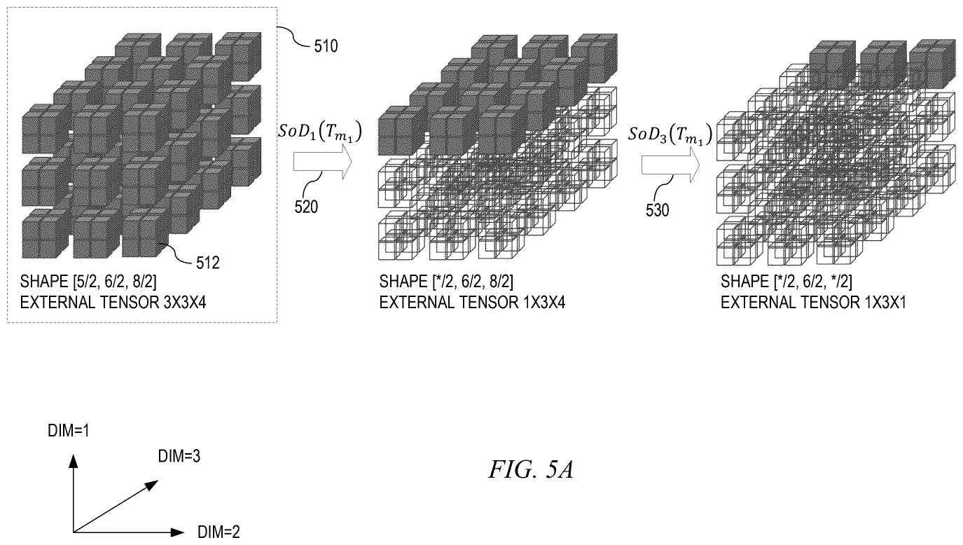

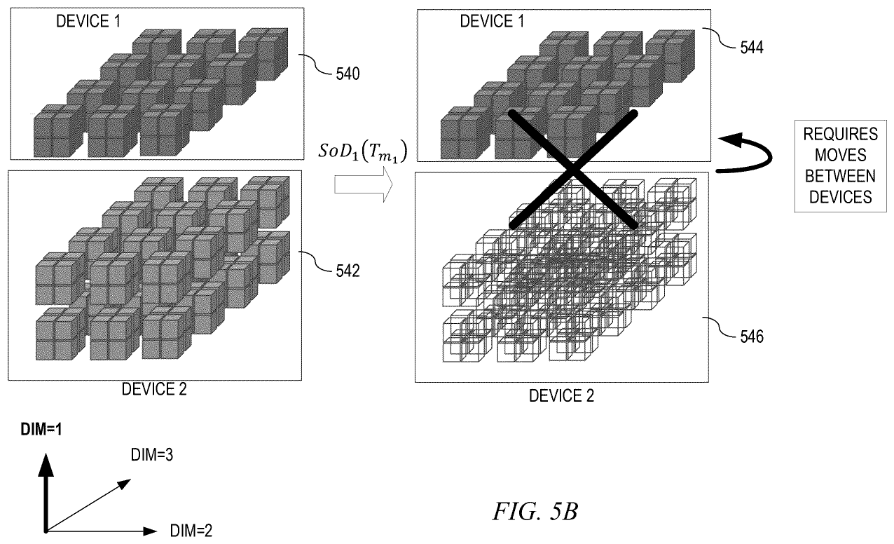

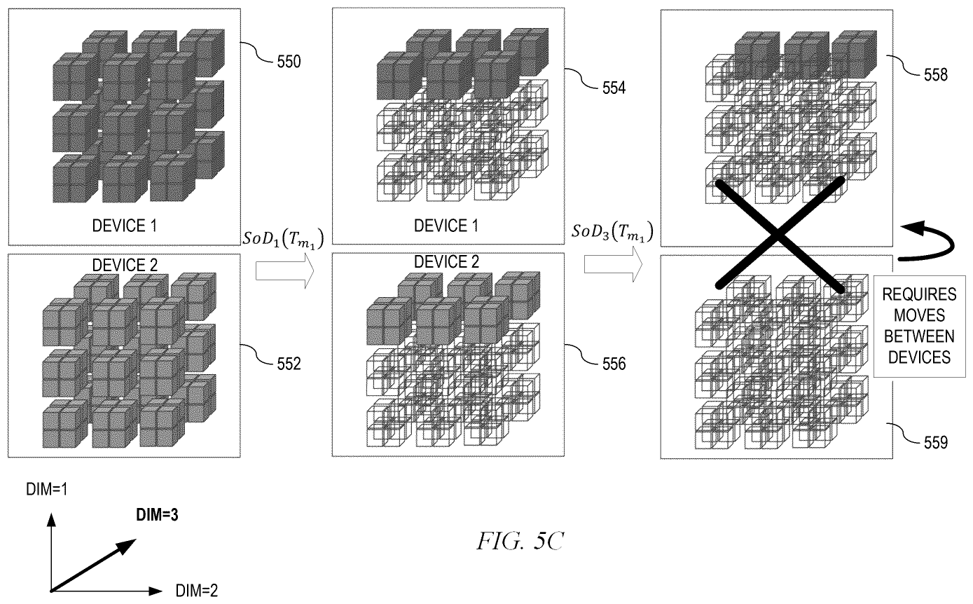

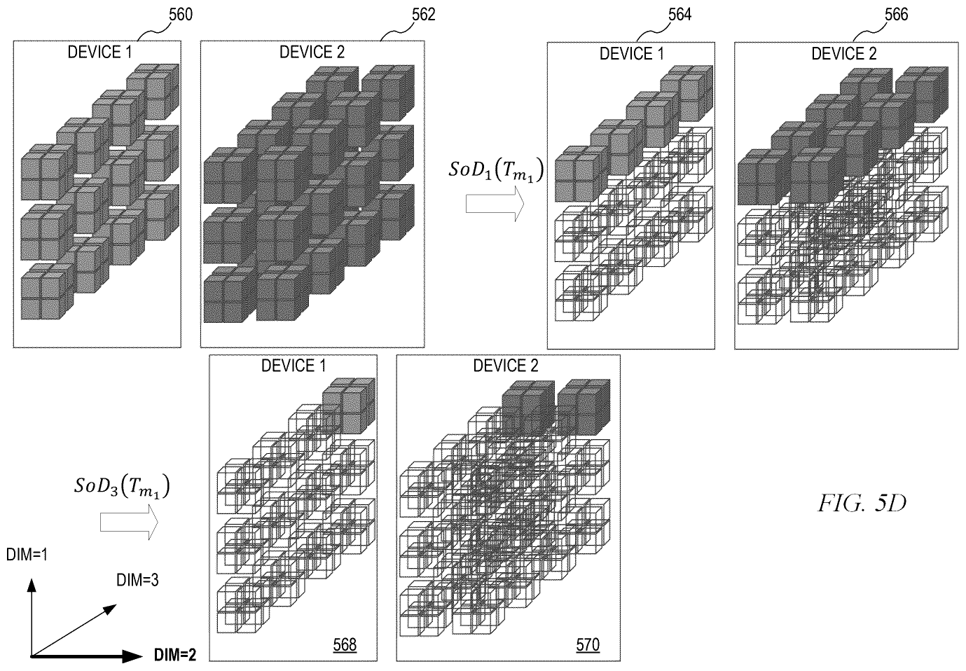

Moreover, during runtime, attempting to evaluate many different options in order to reshape the tile tensors dynamically is may not be practical using such approaches. Consider an example, as shown in FIGS. 5A-5D, of a batch of b=8 matrices m [5×6] that are packed using three dimensional tile tensors Tₘ₁ of shape [5/2, 6/2, 8/2], the external tile tensor 510 of Tₘ₁ is 3×3×4 and stores 36 ciphertexts, each ciphertext being represented in FIGS. 5A-5D as a cube 512 of 8 data elements (2×2×2) of the ciphertext (smaller cubes within cube 512). FIG. 5A illustrates an example execution of a circuit assuming execution on a single device with no splitting of the operations across multiple devices.

With reference to FIG. 5A, assume that the next operations of the circuit are rotate-and-sum (RaS) operations, similar to those described with reference to FIGS. 1A and 1B, along different dimensions of the three-dimensional tile tensor 510. The RaS operation may also be referred to as a sum-over-dimension (SoDₓ) operation, where x is one of the dimensions, e.g., 1 through 3. In the depicted example, a first SoD operation 520, i.e., SoD₁, is performed along the first dimension and then a second SoD operation 530, i.e., SoD₃, is performed along the third dimension. It should be appreciated that the performance of such SoD or RaS operations is a common operation performed in HE computation circuits and thus, this example will demonstrate how tile tensor shape and available devices will affect performance of such HE computations with parallelization, such as SIMD HE operations.

As shown in FIG. 5A, the results of SoD₁(Tₘ₁) 520 will be a tile tensor having shape [*/2, 6/2, 8/2] with external tile tensor size of 1×3×4=12 ciphertexts as the SoD₁ operation compresses, through rotate and addition operations, the ciphertexts into a single layer along the first dimension (the * notation refers to a broadcast of the array). The results of SoD₃(Tₘ₁) 530 will be a tile tensor having shape [*/2, 6/2, *2] with external tile tensor size of 1×3×1=3 ciphertexts, as this second SoD operation compresses, through rotate and addition operations, the ciphertexts along the third dimension.

When running on a single device, e.g., computing device, processor, GPU, or the like, the particular tile tensor shape is not as much of a concern, as long as the tile tensor shape facilitates the size of the original input tensor, as all the computations are performed on a single device. However, a system that attempts to execute the circuit on two or more devices, such as for parallel processing, e.g., SIMD execution, would try to split the tile tensor 510 along one of the dimensions for parallel execution of the SoD operations. For example, if the circuit is executed on two devices, SIMD mechanisms will attempt to split the tile tensor 510 along one of the dimensions in half (assuming the two devices have the same capability). However, it should be appreciated that not every split of a tile tensor is possible without expensive data movement operations having to be performed between the devices.

For example, as shown in FIGS. 5B-5C, dividing the tile tensor Tₘ₁ 510 along the first or third dimension will not result in an optimized evaluation. For example, as shown in FIG. 5B, splitting the tile tensor 510 along the first dimension results in one layer 540 being processed by a first device, while two layers 542 are processed by the other device. When executing the SoD₁ operation, of the example circuit comprising SoD1 and SoD3 in FIG. 5A, on the split tile tensor 510, the second device processes its two allocated layers but then must move the data 546 from the second device to the first device in order to complete the operation with regard to the third layer allocated to the first device and generate the resulting intermediate ciphertext data 544 comprising 12 ciphertexts. Data movements between devices are expensive in terms of performance and are to be avoided if possible.

As shown in FIG. 5C, splitting the tile tensor 510 along the third dimension also results in a required data movement between devices, but with regard to the second SoD operation, i.e. SoD₃. That is, splitting the tile tensor 510 along the third dimension provides a first portion of ciphertexts 550 that are processed by the first device and a second portion of ciphertexts 552 that are processed by the second device, where the first portion is the last 2 vertical layers (furthest from the reader's eye in the three dimensional representation) of the tile tensor 510 and the second portion is the first 2 vertical layers (closest to the reader's eye in the three dimensional representation) of the tile tensor 510. Each device performs the SoD1 operation on their respective layers to compress the ciphertexts to the intermediate ciphertexts 554 and 556 with no data movement between devices necessary. However, when the devices then execute the SoD3 operation on the intermediate ciphertexts 554 and 556, to complete this operation there is again a required data 559 movement from the second device to the first device (the first device being the one processing the last vertical layer of the tile tensor 510), which again is undesirable from a performance perspective.

In contrast, a split along the second dimension, as shown in FIG. 5D, will yield a good result in that no data movements between devices is required to complete the execution of the given circuit, however again the work is no split evenly between the devices. As shown in FIG. 5D, spitting the tile tensor 510 along the second dimension gives a first portion 560, corresponding to the left most layer of the tile tensor 510 being allocated to a first device, while a second portion 562 comprising the two right most layers of the tile tensor 510 being allocated to the second device. When performing the first SoD1 operation, the devices are able to perform this operation without data movement between the devices as each device compresses the ciphertexts to the single layer along the first dimension to generate intermediate ciphertexts 564 and 566. Thereafter, when performing the second SoD3 operation, each device compresses its intermediate ciphertexts 564 and 566 along the third dimension to generate ciphertexts 568 and 570, respectively. No data movement between the devices is needed to complete this operation. The combination of the ciphertexts 568 and 570 represent the same result achieved by the single device as shown in FIG. 5A, however would be obtained with greater speed and lower computer resource consumption due to the parallelization across the two devices.

However, an issue with this split operation along the second dimension is that it results in an imbalance in the allocation of operations (or gates). That is, as shown in FIG. 5D, the second device is having to perform twice as much work as the first device due to the allocation of layers of the tile tensor 510. This will mean that the first device will have to wait for the second device to finish its operations on the split of the tile tensor 510 that it is handling before the results of the circuit may be provided to subsequent computer operations. Thus, latency will still be that of the most heavily loaded device. It would be more beneficial, assuming each device has the same processing capabilities, to evenly distribute the workloads across all the devices such that all the devices will complete execution at approximately the same time.

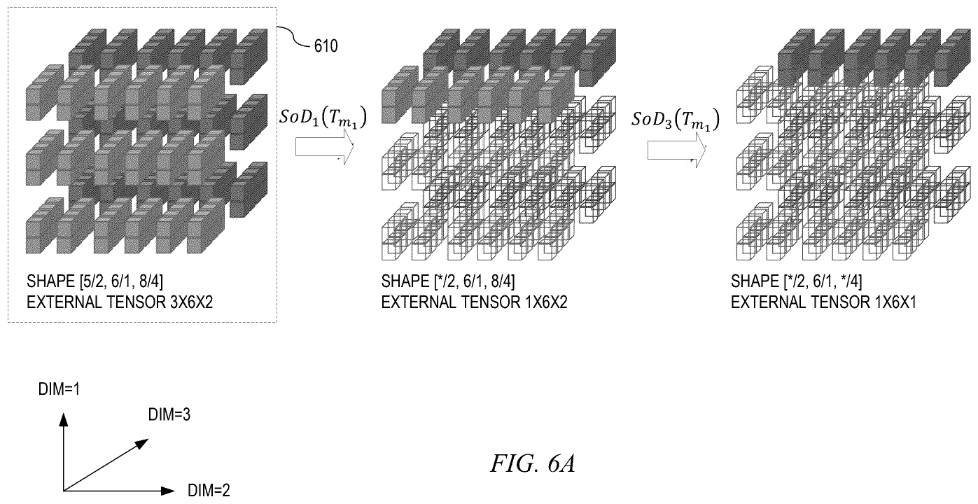

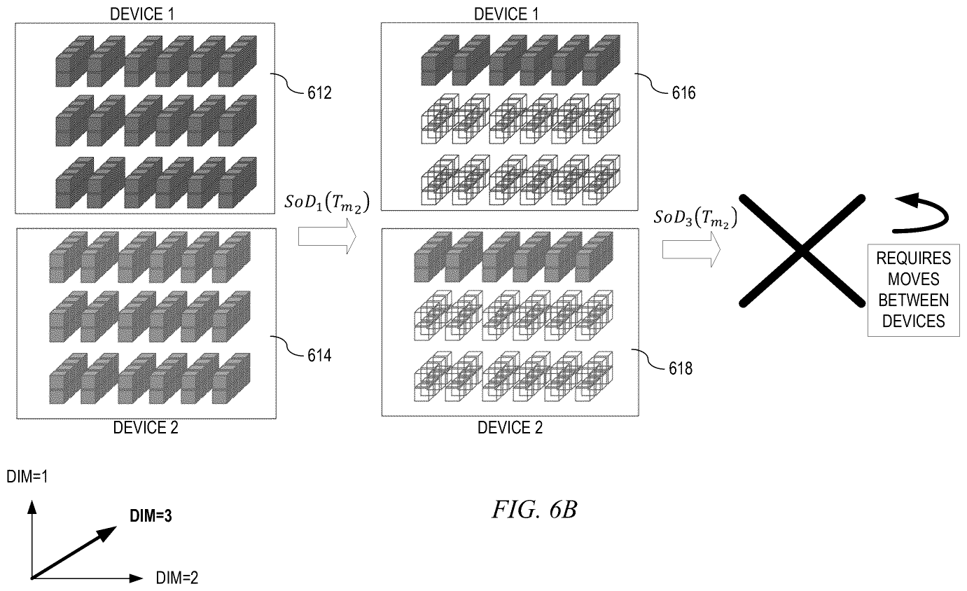

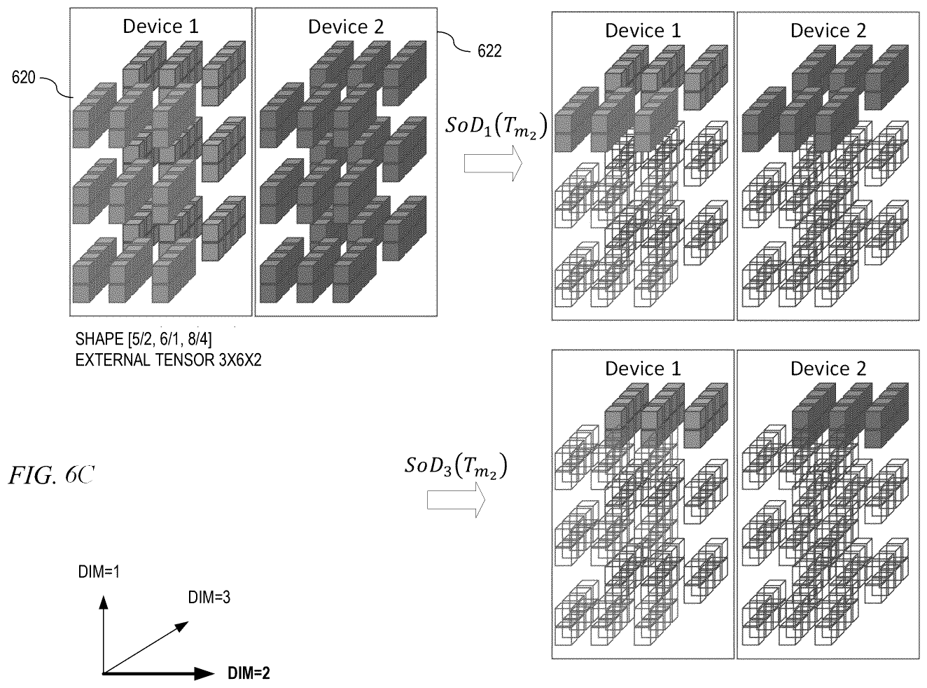

Unlike Tₘ₁, as shown in FIGS. 6A-6C, Tₘ₂ is a different tile tensor shape that is more parallelizable given the above example circuit of SoD₁ and SoD₃. As shown in FIG. 6A, the original tile tensor 610 shape [5/2, 6/1, 8/4] comprises tensors of shape 2×1×4 ciphertexts with the external tile tensor shape being 3×6×2. As shown in FIG. 6A if one executes the circuit without parallelization or SIMD execution, as with FIG. 5A, the tile tensor shape is not of a concern due to all the operations being performed on the same device. The resulting tile tensor shape after the first SoD1 operation is a shape of [*/2, 6/1, 8/4] (external tile tensor shape 1×6×2) and the resulting tile tensor shape after the second SoD3 operation is a shape of [*/2, 6/1, */4] (external tile tensor shape 1×6×1).

However, as shown in FIG. 6B if the ciphertexts are evenly split along the third dimension, generating layers 612 and 614 for devices 1 and 2, respectively, after performing the SoD₁ operation to generate results 616 and 618, a data movement between the devices 1 and 2 would be required when performing the SoD₃ operation for similar reasons as discussed above with regard to FIG. 5C. As shown in FIG. 6C, however, if the split is performed along the second dimension to generate layers 620 and 622 for devices 1 and 2, respectively, no data movement between devices is required, similar to FIG. 5D. In addition, as shown in FIG. 6C, the workload of each device is the same and hence, each device will finish its execution of the circuit at approximately a same time and no device need wait for the other device to complete its execution.

Thus, in an example scenario having two devices as set forth above, it is better to use Tₘ₂ instead of Tₘ₁. This simplified example shows the issue of parallelization being dependent upon tile tensor shape and number of devices available to perform parallel executions. This issue only gets more problematic when operating at larger scales, such that it is not possible to determine through manual or mental means what tile tensor shape to utilize given the circuit operations that are to be performed and the number of devices available for parallel execution. This is especially true when one considers that it is not known ahead of time what the size of the input ciphertexts will be, and thus the original input tensor, as these are dependent upon the particular encryption keys utilized. Furthermore, it is not known ahead of time what the status of the devices will be at any given time and thus, while a circuit may be allocated a set of devices for parallel or SIMD execution, when it comes time to execute a circuit, or an operation withing a circuit, the same number of devices may not be available, i.e., the number of devices is dynamic.

To further explain this point, consider that there are three stages for application generation and execution: writing the code, planning the execution, and then execution. The developer writes a single code which will be used for many input sizes. Continuing the example of FIGS. 5A-5D and 6A-6D, consider that a system classifies a batch of images. Here, two dimensions of the tensor are the spatial dimensions of the image and the third dimension is a batch dimension. When writing the code, the developer does not know what the size of the tensor is going to be. So, any planning based on the tensor cannot be done at the first stage. When the input size becomes known, e.g., at the second stage, the execution can be planned and then only at the execution stage are the number of available resources known.

It should also be noted that, while an HE layers optimizer may have knowledge of how to write a HE circuit given a chosen fixed tile tensor shape, the HE layer optimizer operates offline and thus, does not have information about the device status in real-time, i.e., the HE layers optimizer does not have any information regarding the dynamic operating conditions of the devices available to perform the HE circuit operations in a SIMD or parallelized manner. In contrast, the circuit evaluation layer (CircLayer) is familiar with the device status at different periods of time, but sees the circuit only at the gate level, where the “gates” are the set of operations that depend on the shape of the tensor used, and therefore cannot schedule efficiently a reshape operation.

Thus, what is needed is an improved computing tool and improved computing tool operations/functionality, such as may be provided at the circuit evaluation layer for example, that leverages extra knowledge to dynamically reshape tile tensor to efficiently utilize the parallelization of the available hardware. The illustrative embodiments provide such an improved computing tool and improved computing tool operations/functionality.

The improved computing tool and improved computing tool operations/functionality, in accordance with some illustrative embodiments in which homomorphic encryption (HE) computations are to be performed, automatically analyzes, in an offline phase of operation, a given application which may be represented as an HE circuit having one or more HE compute operations and intermediary ciphertext results, according to compute device (e.g., processor, GPUs, etc.) availability and a predetermined set of possible tile tensor shapes. The predetermined set of possible tile tensor shapes may be stored as configuration parameters and may represent different tile tensor shapes of different dimensions and numbers of dimensions. The particular possible tile tensor shapes may be different for each user of the illustrative embodiments and may be specified as configuration parameters in general or for a specific HE circuit and/or workload submitted by the user. These may be selected via a user interface to the improved computing tool and may be selected from a predefined group of tile tensor shapes.

The static analysis generates, for one or more sub-circuits or “slices” of the HE circuit, a recommended tile tensor shape. In illustrative embodiments, this selection may be performed only with regard to a first sub-circuit or slice, or a first predetermined number of sub-circuits or slices, e.g., the first two sub-circuits or slices. The tile tensor shape for subsequent sub-circuits or slices may be dynamically determined during runtime through similar dynamic simulations of the next X number of sub-circuits or slices to select a next tile tensor shape that will optimize the packing and parallel execution of the next X sub-circuits or slices (hereafter referred to as simply “slices”). In other illustrative embodiments, this may be performed for the entire circuit such that a recommended tile tensor shape is generated for each sub-circuit or slice in the HE circuit.

The tile tensor shape selection is based on a static analysis of the HE circuit, which may be represented as a graph of nodes representing HE compute operations of the circuit, and edges representing intermediate tile tensor outputs of the nodes having intermediate ciphertexts, to select a tile tensor shape that results in a highest performance circuit path (e.g., lowest latency path), through slices of the circuit, or sub-circuits, based on simulations of the circuit slices using different tile tensor shapes and different numbers of available devices. These simulations may be previously performed for different types of sub-circuits or slices and for different numbers and types of available devices, e.g., a CPU, one GPU, 2 GPUs, etc., and the results stored in a lookup table. Thus, based on a number of devices available and a type of sub-circuit or slice, i.e., what HE compute operations are being performed, the offline phase mechanisms may retrieve the expected performance for various tile tensor shapes and determine the appropriate tile tensor shape to use when executing a given subcircuit or slice of the HE circuit. Moreover, the costs, in terms of performance (e.g., latency), may be determined for reshaping operations for reshaping the data from one tile tensor shape to another in the possible tile tensor shapes. Reshaping involves the movement of data and thus, has a latency and resource utilization cost and this may be simulated for each pairing of tile tensor shapes. It can be appreciated that in some cases, while a different tile tensor shape may make packing of ciphertexts for a next sub-circuit or slice more efficient for parallel execution of this next sub-circuit or slice, the performance impact of the reshape operation may negate any performance benefit of the different tile tensor shape, or even make the performance worse in some cases, such that a transition to a different tile tensor shape is not the optimum option to select. This may be evaluated when determining the optimum tile tensor shapes for the sub-circuits or slices of the HE circuit.

Thus, given an HE circuit specifying the HE operations that are to be performed on input ciphertexts, during the static analysis in which previous simulations have been performed and the results stored in a lookup table, the offline phrase mechanisms may perform a lookup in the lookup table for the particular sub-circuits and expected number of devices, to determine the performance along the HE circuit for different possible paths of tile tensor shapes for the various sub-circuits or slices of the HE circuit. For example, if the performance metric is latency, then the simulations may determine a compute time or latency for each type of sub-circuit or slice, and for each number of available devices and each possible tile tensor shape in a set of possible tile tensor shapes and store that information for later retrieval by a lookup operation. These latencies of each of the individual sub-circuits or slices, as well as any possible reshaping operations to move from one tile tensor shape to another, may be aggregated to generate a total latency or compute time for the circuit given the specific selection of tile tensor shapes and reshaping operations. A shortest path, e.g., lowest latency path, may then be selected from these various options of tile tensor shapes, which may involve different tile tensor shapes for different sub-circuits or slices and different reshaping operations when transitioning from one tile tensor shape to another.

It should be appreciated that the offline phase of operation does not require that the simulation be performed ahead of time and results stored in a lookup table, as this is only one possible embodiment. To the contrary, in other illustrative embodiments, the simulations may be performed with regard to the specific sub-circuits or slices of the given HE circuit in response to receiving the HE circuit for execution during runtime on provided ciphertext data. That is, rather than performing a lookup operation, the offline phase mechanisms of the illustrative embodiments may execute the simulation of each sub-circuit or slice and generate the predicted performance results given variations in tile tensor shape and available devices. A highest performing, e.g., lowest latency, path of tile tensor shapes and reshape operations may then be selected for use in executing the HE circuit.

Again, it should be appreciated that this simulation may be performed with regard to a subset of the sub-circuits or slices, e.g., the first slice or first few slices, or for the entire HE circuit. This may result in different tile tensor shapes being selected for difference slices or sub-circuits of the circuit and thus may require the application of tile tensor reshape operations between the slices to more efficiently perform HE packing in the tile tensors. This is to facilitate more efficient HE packing such that the tile tensor can be split between the available devices efficiently and in as much of a balanced manner as possible. The selection based on the static analysis may be limited to only the particular number of devices predicted to be available to execute the HE circuit, e.g., if 3 or more GPUs is not a possibility under current situations, e.g., the client has not engaged cloud services to provide 3 or more GPUs, the system only provides a maximum of 2 GPUs, or the like, then only 0, 1, or 2 GPUs will be evaluated and selections made based on this limitation on available devices.

Thus, for example, in some illustrative embodiments, a tile tensor shape optimizer, as part of an offline operation, receives an application, i.e., HE circuit, to be executed under HE. The tile tensor shape optimizer also receives a list of possible devices that may be used to execute the HE circuit in a SIMD or parallel manner, and the tile tensor shape optimizer generates a map to break the application into slices, i.e., sub-circuits. For example, in some illustrative embodiments, when the HE circuit implements a neural network, a slice can be a single layer in the neural network. In another illustrative embodiment, a slice can be any node in a tensor-graph (described hereafter), since each node represents one or more operations on a tile-tensor and includes one or more HE operations. Of course other illustrative embodiments of HE circuits and corresponding slices may be used without departing from the spirit and scope of the present invention.

The tile tensor shape optimizer of the illustrative embodiments executes either by brute-forcing all the different shapes or by selecting only some of them for simulation and evaluation. For every tile tensor shape selected for evaluation, the tile tensor shape optimizer simulates or computes the runtime performance under different device availability configurations, e.g., 1, 2, 3, 4, etc. devices available, or alternatively, the tile tensor shape optimizer may compute the level of parallelization of a slice, i.e., the least amount of data movement between devices if X devices exist. It should be noted that, for each sub-circuit or slice, the number of sub-circuit or slice simulations and evaluations is the number of devices (# devices) multiplied by the number of shapes (# shapes), i.e., # devices×# shapes. Thus, in some cases, as noted above, these simulations may be performed ahead of time and stored in the lookup table so that an approximate performance for a given HE circuit may be determined from retrieval of the stored simulation results for given sub-circuits or slices of the HE circuit, number of available devices, and possible tile tensor shapes. The result is an initial recommendation of tile tensor shapes to utilized for one or more of the sub-circuits or slices of the HE circuit.

Subsequently, in an online phase, the illustrative embodiments may implement a dynamic tile tensor shape optimizer of a circuit evaluation layer, e.g., CircLayer, to dynamically determine the device availability status and dynamically analyze the HE circuit for various combinations of tile tensor shapes and device availability. The dynamic tile tensor shape optimizer may then dynamically adapt the tile tensor shapes and perform reshape operations to achieve an optimized execution of the HE circuit based on runtime conditions. In some cases, this may involve performing lookup operations in the simulation result lookup tables, or executing runtime simulations, of the next Y number of slices or sub-circuits in the HE circuit for various tile tensor shapes and a current number of available devices as determined dynamically by the CircLayer. This may again take into consideration the performance impact of inserting reshape operations to transition from one tile tensor shape to another. Thus, similar to the offline phase of operation, during the runtime or online phase of operation, the selection of tile tensor shapes for subsequent sub-circuits or slices may be performed, but instead with a runtime knowledge of the available devices to perform parallel execution by splitting the tile tensor across the available devices.

It should again be appreciated that, with the illustrative embodiments, instead of considering just one potential (optimized) circuit, which is the result of an HE circuit optimizer's fixed selection of a tile tensor shape, the improved computing tool and improved computing tool operations/functionality evaluate a complex combination of multiple possible tile tensor shapes, multiple possible available devices, and different sub-circuits or slices of an HE circuit. These options maybe represented as a multi-dimensional circuit, e.g., three dimensional circuit, where in every surface (x, y axes) there is an HE circuit corresponding to a given tile tensor shape. In a three-dimensional circuit implementation, the z-axis defines the different evaluated tile tensor shapes, the x axis representing different slices or sub-circuits of the HE circuit, and the y axis representing different numbers of available devices. At every slice border along he x-axis in this three-dimensional circuit, there is an option “to move” between x-y surfaces by executing a reshape operation. Note that the sub-circuits on each x-y surface, per slice, perform the same logical operation, i.e., they have the same inputs/outputs, and just the format of encoding (packing) of the data is different for the different tile tensor shapes.

The dynamic tile tensor shape optimizer of the illustrative embodiments may evaluate this multi-dimensional circuit at various times during execution of the HE circuit, e.g., at each slice boundary or just prior to a slice boundary, e.g., when a previous HE operation of a previous slice or sub-circuit is X % complete, e.g., 90% complete, to determine whether for a next sub-circuit or slice, or a next predetermined number of sub-circuits/slices, a change in tile tensor shape will result in improved performance, which includes evaluating the overhead of performing the reshape operation itself. That is, in addition to determining the runtime performance under different device availabilities, the dynamic tile tensor shape optimizer also computes the cost of performing a reshape operation between every pair of possible tile tensor shapes. This information is added as a gate between the x-y surfaces of the multi-dimensional circuit and allows a dynamic tile tensor shape optimizer of the circuit evaluation layer (CircLayer) to dynamically determine what surface (tile tensor shape) to use per slice.

Thus, at the circuit evaluation layer (CircLayer) a multi-dimensional graph (e.g., three-dimensional graph) of the multi-dimensional circuit may be utilized by the dynamic tile tensor shape optimizer, where the graph has nodes representing corresponding sub-circuits or slices, surfaces representing different tile sensor shapes, and edges representing transitions from one slice to another, which may include gates for reshaping tile tensor shapes. The multi-dimensional graph is evaluated by the dynamic tile tensor shape optimizer of the CircLayer with regard to the recommended first slice(s) tile tensor shape, as determined during the offline phase, according to the available devices determined during the online phase. At every slice border (or some gates before it, e.g., at X % completion of the prior slice) the dynamic tile tensor shape optimizer of the CircLayer tests the available hardware devices and checks which sub-circuit or slice tile tensor shape provides the highest level of parallelization (e.g., lowest latency, lowest number of data movements between devices, or the like) within the next Y number of slices, where Y may be any value suitable to the particular implementation, e.g., Y=1, 2, 3, etc. The dynamic tile tensor shape optimizer of the CircLayer also takes into account the expected performance cost, e.g., latency, memory usage, or the like, of reshaping the data to move to a new tile tensor shape from a previous tile tensor shape. The dynamic tile tensor shape optimizer of the CircLayer greedily finds the best solution for a given dynamic situation of the available devices. In some illustrative embodiments, the dynamic tile tensor shape optimizer can attempt to predict the available devices in future slices and dynamically choose the best sub-circuit tile tensor shape to evaluate at a given time.

Thus, the illustrative embodiments provide an improved computing tool and improved computing tool operations/functionality to dynamically determine the optimum tile tensor shape for slices of an application or circuit, e.g., a HE circuit, based on available parallelization capabilities of the available hardware. The illustrative embodiments evaluate a variety of different tile tensor shapes, as well as the performance overhead required for reshaping tile tensors from one tile tensor shape to another, and selects a tile tensor shape for a next sub-circuit or slice based on a determination of an optimized performance given the dynamic conditions of the available hardware devices and parallelization capabilities. Thus, rather than utilize a fixed tile tensor shape, the illustrative embodiments are able to dynamically adapt the tile tensor shape during runtime execution of an application or circuit, e.g., HE circuit, based on the dynamically changing conditions of available hardware devices for performing parallel, e.g., SIMD, execution of compute operations on data elements, such as ciphertexts of HE operations of an HE circuit. This improves the performance of HE operations and HE circuits by reducing latency, memory usage, throughput, and communication costs.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an improved HE layers optimizer and circuit evaluation layer (CircLayer) which evaluates a plurality of different tile tensor shapes for a given circuit and selects, both initially (statically) and dynamically during runtime, a tile tensor shape, and corresponding reshape operations if needed, for executing the given circuit in an optimized manner. The improved computing tool implements mechanism and functionality, such as the HE layers optimizer and CircLayer, which cannot be practically performed by human beings either outside of, or with the assistance of, a technical environment, such as a mental process or the like. The improved computing tool provides a practical application of the methodology at least in that the improved computing tool is able to select tile tensor shapes, and dynamically adapt the tile tensor shapes to the runtime conditions when executing a given circuit, based on a simulation and evaluation of a variety of different possible tile tensor shapes and their corresponding impact on performance measures, e.g., latency, memory usage, throughput, communication, etc.

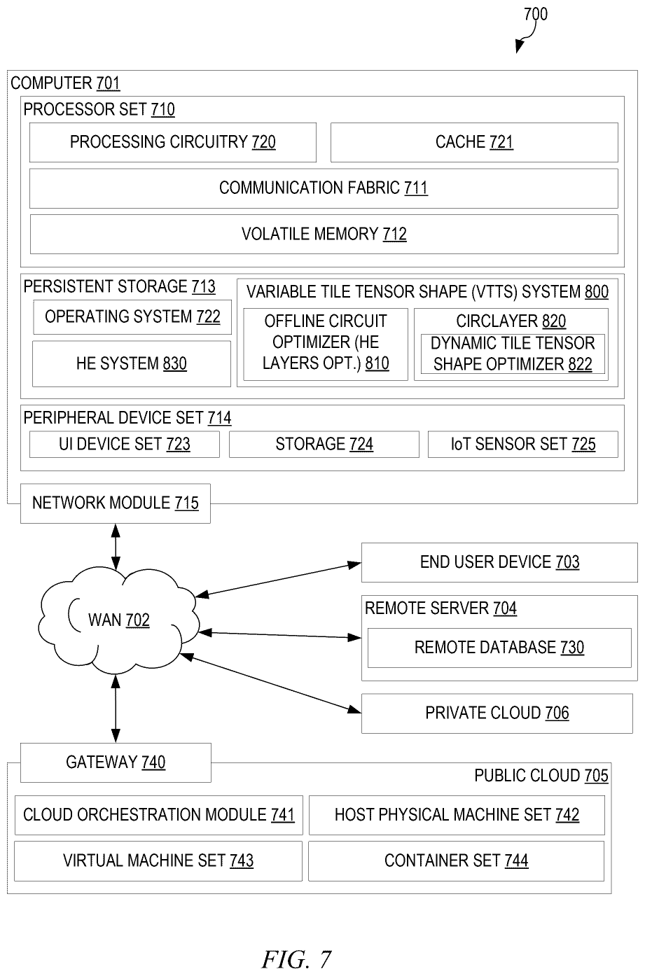

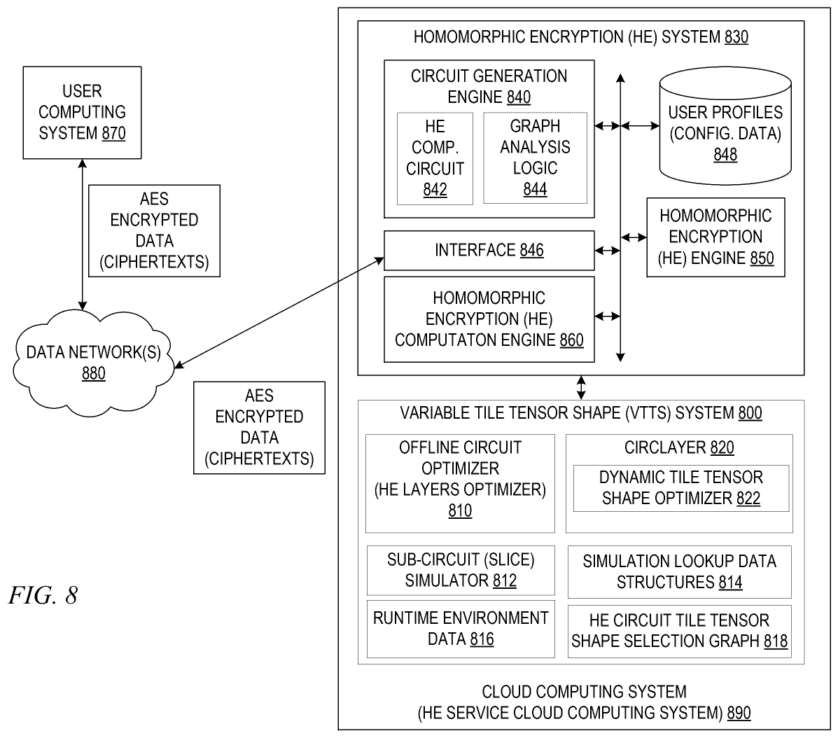

FIG. 7 is an example diagram of a distributed data processing system environment in which aspects of the illustrative embodiments may be implemented and at least some of the computer code involved in performing the inventive methods may be executed. That is, computing environment 700 contains an example of an environment for the execution of at least some of the computer code involved in performing the inventive methods, such as variable tile tensor shape (VTTS) system 800 comprising an offline circuit optimizer 810, which for purposes of illustration is assumed to be a homomorphic encryption (HE) layers optimizer for a HE service but is not limited to HE, and a CircLayer 820 with dynamic tile tensor shape optimizer 822. In addition, the computing environment 700, in illustrative embodiments of an HE service, may also host other components of an HE service, such as HE system 830 described with regard to FIG. 8 hereafter.

In addition to VTTS system 800, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and VTTS system 800, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in VTTS system 800 in persistent storage 713.

Communication fabric 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface type operating systems that employ a kernel. The code included in VTTS system 800 typically includes at least some of the computer code involved in performing the inventive methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

As shown in FIG. 7, one or more of the computing devices, e.g., computer 701 or remote server 704, may be specifically configured to implement an VTTS system 800. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 701 or remote server 704, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates tile tensor shape selection both initially through static analysis of the compute operations of an application (or circuit), such as an HE circuit, and dynamically during runtime while the circuit is being executed. The tile tensor shape selection mechanisms improve the performance of the computing device with regard to the execution of the circuit in a parallel or SIMD manner by selecting a tile tensor shape that provides an optimum packing of batch of data elements, e.g., ciphertexts, for splitting across available devices able to execute the circuit in parallel on different portions of the ciphertexts.

FIG. 8 is an example diagram of the primary operational components of a variable tile tensor shape (VTTS) computer tool in accordance with one illustrative embodiment. The operational components shown in FIG. 8 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings and the resulting output may aid human beings. The invention is specifically directed to the automatically operating computer components directed to improving the way that data elements are packed into tile tensors for optimum parallel execution of an application (circuit), where the improvement provides mechanisms that provide a static offline analysis of the application (circuit), including simulation of sub-circuits or slices of the circuit with regard to different tile tensor shapes and numbers of available devices for parallel execution, and dynamic online analysis of the execution of the circuit given a current number of available devices, so as to dynamically adapt the tile tensor shape used to the current status of the computing environment. As such, the mechanisms and operations performed by the illustrative embodiments cannot be practically performed by human beings as a mental process and are not directed to organizing any human activity.

The illustrative embodiments described herein with regard to the following figures will assume application to a HE service and operation on HE circuits which are used to process batches of input ciphertexts from client computing systems using HE computation operations, which again are operations that operate on encrypted data (input ciphertexts) without decrypting the data. As shown in FIG. 8, a VTTS system 800 is provided as either a separate service for one or more cloud computing systems (HE service cloud computing system) 890 or integrated into the cloud computing systems 890. In the depicted example, the VTTS system 800 is integrated into the cloud computing system 890, which is assumed to be an HE service cloud computing system 890 that provides a HE computation service. In other illustrative embodiments, the VTTS system 800 may operate to dynamically adapt tile tensor shapes for optimized parallel execution of HE computation operations for a given HE computation circuit (or simply HE circuit) 842 and provide tile tensor shape selections to the cloud provider system 890 which implements HE mechanisms and may utilize the tile tensor shape selections to execute the HE circuit 842 and process a batch of input ciphertexts, e.g., Advanced Encryption Standard (AES) encrypted data, and provide resulting ciphertexts back to the user computing system 870, e.g., AES encrypted results. In such a case, the cloud provider system 890 is configured to perform the initial static analysis of a given HE computation circuit having one or more HE computation operations that are executed on ciphertexts, in order to select an initial tile tensor shape for packing ciphertexts for optimum parallel, e.g., SIMD, execution based on simulation of the sub-circuits with regard to various possible tile tensor shapes and various possible available devices for parallel execution.

The various possible tile tensor shapes may be stored as configuration parameters and may represent different tile tensor shapes of different dimensions and numbers of dimensions, e.g., 3×3×4 or 3×6×2 in the previously depicted examples, although it should be appreciated that the tile tensor shapes are not limited to three dimensions. As mentioned previously, the particular possible tile tensor shapes may be different for each user computing system 870 and may specified as configuration parameters in general or for a specific HE circuit 842 and/or workload submitted by the user computing system 870. These may be selected via a user interface 846 and may be selected from a predefined group of tile tensor shapes, for example. Similarly, the number of available devices (CPUs, GPUs, etc.) may be different for each user computing system 870. These user computing system 870 specific parameters may be stored in corresponding user profiles in the storage 848.

In addition, the cloud provider system 890 is configured to perform dynamic analysis of the given HE computation circuit 842 during execution in order to dynamically adapt the tile tensor shape based on the subsequent sub-circuits or slices that are to be executed and the currently available devices to perform parallel execution, which may again involve simulation of these subsequent sub-circuits with various possible tile tensor shapes. In other embodiments, where the VTTS system 800 is integrated with the cloud computing system 890, for example, the VTTS system 800 may operate to perform the tile tensor shape optimization operations of the illustrative embodiments, as provided by the VTTS system 800.

As shown in FIG. 8, the cloud computing system 890 includes a HE system 830 which has an input interface 846 through which user data, e.g., registration of HE circuits for execution, requests to generate HE circuits, batches of input ciphertexts, etc., may be received from user computing system 870, and results of the operations may be returned to the submitter of the requests, ciphertexts, etc. For example, when presented with a batch of ciphertexts to process using HE mechanisms and a specified HE circuit 842 which may be provided by the submitter or generated by the circuit generation engine 840 in response to a request, e.g., inputs form user computing system 870, the operation of the HE computations of the given HE circuit 842 on the batches of input ciphertexts (workloads) may be returned or sent to appropriate computing systems 870 via the one or more wired/wireless data networks 880. It should be appreciated that the “user” and “user system” 870 in this depiction is not limited to an individual person and individual computing system, but rather may represent an organization or group, or even an automated computing system that submits data to the HE service cloud computing system 890 for processing, and may include more than one computing system 870. For ease of explanation, the depiction shows a single user computing system 870, but this is not intended to be limiting on the present invention.

The user computing system 870 may submit data to the cloud computing system 890 via the network(s) 880 both as part of a preliminary configuration operation and as a runtime processing of submitted workload data via a previously provided or generated HE circuit 842 having HE computation operations specified in the HE circuit 842. In a preliminary configuration operation, the user of a user computing system 870, provides configuration information for use with workloads of data, i.e., batches of ciphertexts, that are to be processed in runtime operation. This preliminary configuration operation may occur such as when the user, via the user computing system 870, first registers with the cloud computing system 890, whenever an HE circuit is to be modified, or at any other time when the user requests that a new configuration of an HE circuit 842 for processing workloads is to be implemented by the HE service of the cloud computing system 890.

As part of this preliminary configuration operation, the user of the user system 870 specifies the types of workloads that will be processed, a HE circuit 842 comprising a sequence of HE computations that are to be performed on subsequent workloads or a requested operation that the user wishes to be performed on ciphertexts, from which an HE circuit 842 may be generated by the circuit generation engine 840, and any other required configuration parameters, e.g., a map for slicing the HE circuit 842 into sub-circuits or slices, which may be stored in a user profiles data storage 848. The user profiles data storage 848 may store user profiles with HE circuit specifications and corresponding configuration parameters for a plurality of different user computing systems 870.

As noted above, in some illustrative embodiments, rather than the user computing system 870 having to provide the HE circuit 842, the specification of the HE circuit 842 may be the description of a result that the user wishes to obtain when the workload is processed or may be a specific step-by-step process of HE computations that are to be performed on the workloads, i.e., a user specified HE circuit. In the case that the specification is a description of the result to be generated, e.g., process my workloads and return X, the mechanisms of the HE service cloud computing system 890 may generate the HE circuit 842 from the description of the results of the workload. For example, given the type of workload that is to be processed, and given the result that is to be generated, the circuit generation engine 840 of the cloud computing system 890 may generate a circuit 842 of intermediate HE computations that can take the specified type of workload input and generate the requested result.

Alternatively, the user can specify the particular HE circuit 842 including the intermediate HE computations that are to be performed to achieve the desired results given the type of workload. In addition, the circuit generation engine 840 and/or user computing system 870 may generate/provide a map for partitioning or slicing the HE circuit 842 into sub-circuits or slices for use by the VTTS system 800 to optimize parallel execution of the HE circuit 842 on batches of input ciphertexts (workloads).

During the preliminary configuration operation, which is part of an offline phase of operation, the VTTS system 800 analyzes the generated or given HE circuit 842 in accordance with a given (or circuit generation engine 840 generated) map for generating sub-circuits or slices of the HE circuit 842, to statically determine an initial set of tile tensor shapes for the sub-circuits/slices. The map associates HE operations to slices of the HE circuit. The initial set of tile tensor shapes are the tile tensor shapes that are predicted to be optimal for use in packing the input ciphertexts of input workloads for optimum parallel (SIMD) execution by an expected number of devices (GPUs, CPUs, or the like). The offline circuit optimizer 810, which in some illustrative embodiments is a HE layers optimizer 810, automatically analyzes the given application, which is represented by the HE circuit 842 having one or more HE compute operations and intermediary ciphertext results, according to each possible combination of compute device (e.g., CPU, GPUs, etc.) availability and tile tensor shapes in a predetermined set of possible tile tensor shapes. This analysis may involve performing sub-circuit (or slice) simulations using the sub-circuit (slice) simulator 812 on each combination. The simulator 812 simulates a given sub-circuit (slice) or set of sub-circuits (slices) for the different combinations of the possible tile tensor shapes and the possible numbers of available devices and generates performance metric information for the particular combinations, e.g., latency, throughput, resource utilization, level of parallelization, amount of data movement required for pairings of tile tensor shapes, and the like. That is, the simulation performed by the simulator 812 may not only simulate the sub-circuit (slice) itself, but may also simulate transitions of tile tensor shapes from one shape to another for subsequent sub-circuits or slices so as to predict the performance impact of such tile tensor shape transitions. Summing the performance metrics of the simulated sub-circuits and the transitions between tile tensor shapes can give an overall performance metric for the simulated sub-circuits or slices.

The static analysis of the offline circuit optimizer 810 generates, for one or more sub-circuits or “slices” of the HE circuit 842, a recommended tile tensor shape. This may be performed for all of the sub-circuits or slices of the HE circuit 842 or for a select set of sub-circuits or slices less than the whole HE circuit 842. In illustrative embodiments, this selection may be performed only with regard to a first sub-circuit or slice, or a first predetermined number of sub-circuits or slices, e.g., the first two sub-circuits or slices. The tile tensor shape for subsequent sub-circuits or slices may be dynamically determined by the dynamic tile tensor shape optimizer 822 of the CircLayer 820 during the runtime, or online phase of operation, through similar dynamic simulations by the simulator 812, but of the next X number of sub-circuits or slices to select a next tile tensor shape that will optimize the packing and parallel execution of the next X sub-circuits or slices. In other illustrative embodiments, this may be performed for the entire HE circuit 842 such that a recommended tile tensor shape is generated for each sub-circuit or slice in the HE circuit based on the simulation 812 of these slices by the dynamic tile tensor shape optimizer 822 invoking the sub-circuit (slice) simulator 812, using the runtime environment data 816 obtained from the runtime environment of the HE system 830 to determine what devices are available for simulation of the slices for each of the possible tile tensor shapes.

During the offline phase of operation, the tile tensor shape selection is based on a static analysis of the HE circuit 842, which may be represented as a graph (or tensor-graph) of nodes that represent HE operations and edges representing the intermediate ciphertexts or tile tensors results of the HE operations of the connected node. Such static analysis may be performed on the graph by the graph analysis logic 844, for example. The tile tensor shape selection selects a tile tensor shape that results in a highest performance circuit path (e.g., lowest latency path), through slices of the circuit, or sub-circuits, based on simulations of the circuit slices using different tile tensor shapes and different numbers of available devices. These simulations may be previously performed for different types of sub-circuits or slices and for different numbers and types of available devices, e.g., a CPU, one GPU, 2 GPUs, etc., and the results stored in a simulation lookup data structures 814 of the sub-circuit simulator 812. Thus, based on a number of devices available and a type of sub-circuit or slice, i.e., what HE compute operations are being performed, the offline circuit optimizer 810 may invoke the sub-circuit simulator 812 which may retrieve the expected performance for various tile tensor shapes from its simulation lookup data structures 814 and determine the appropriate tile tensor shape to use when executing a given subcircuit or slice of the HE circuit 842.

Moreover, the costs, in terms of performance (e.g., latency), may be determined for reshaping operations for reshaping the data from one tile tensor shape to another in the possible tile tensor shapes, and the performance metrics of such transitions or reshaping operation may be stored in the simulation lookup data structures 814 as well. Again, reshaping, or transitioning from one tile tensor shape to another, involves the movement of data and thus, has a latency and resource utilization cost which may be simulated by the sub-circuit simulator 812 for each pairing of tile tensor shapes. It can be appreciated that in some cases, while a different tile tensor shape may make packing of ciphertexts for a next sub-circuit or slice more efficient for parallel execution of this next sub-circuit or slice, the performance impact of the reshape operation may negate any performance benefit of the different tile tensor shape, or even make the performance worse in some cases, such that a transition to a different tile tensor shape is not the optimum option to select. This may be evaluated by the offline circuit optimizer 810 and the dynamic tile tensor shape optimizer 822 when determining the optimum tile tensor shapes for the sub-circuits or slices of the HE circuit 842 in the online phase and the offline phase.

Thus, given an HE circuit 842 specifying the HE operations that are to be performed on input ciphertexts from the user computing system 870, during the static analysis by the offline circuit optimizer 810 invoking the sub-circuit simulator 812, in which previous simulations have been performed and the results stored in simulation lookup data structures 814, the sub-circuit simulator 812 may perform a lookup in the simulation lookup data structures 814 for the particular sub-circuits and expected number of devices, to determine the performance along the HE circuit 842 for different possible paths of tile tensor shapes for the various sub-circuits or slices of the HE circuit 842. Based on the relative performance along the HE circuit 842 for each of the possible paths, a path having the relatively best performance may be selected and thus, the corresponding tile tensor shapes and reshape operations may be selected for the subject portion of the HE circuit 842, e.g., a first predetermined number of sub-circuits/shapes or the entire HE circuit 842 in the case of the offline evaluation, a next X number of sub-circuits/shapes during an online dynamic tile tensor shape optimization operation, or the like.

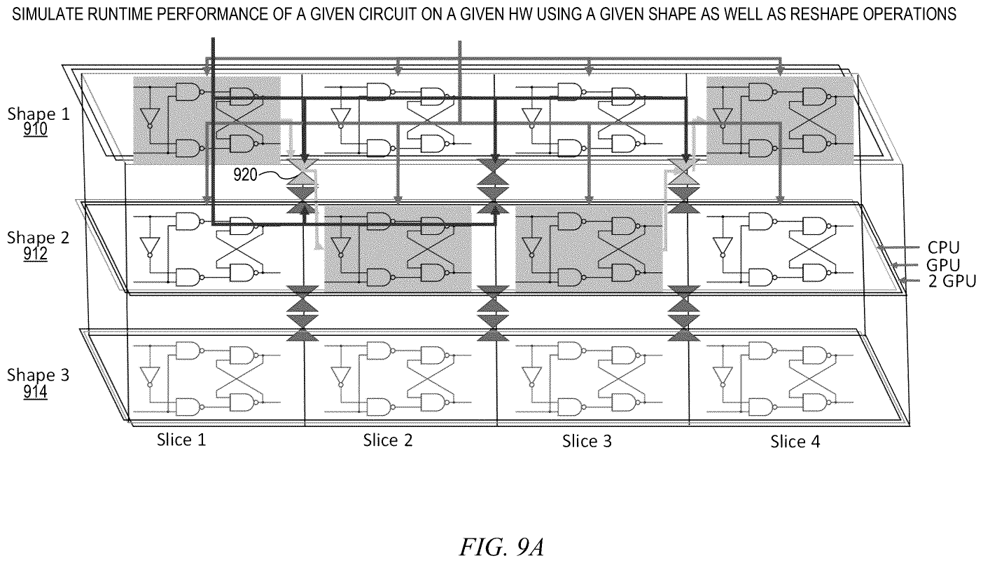

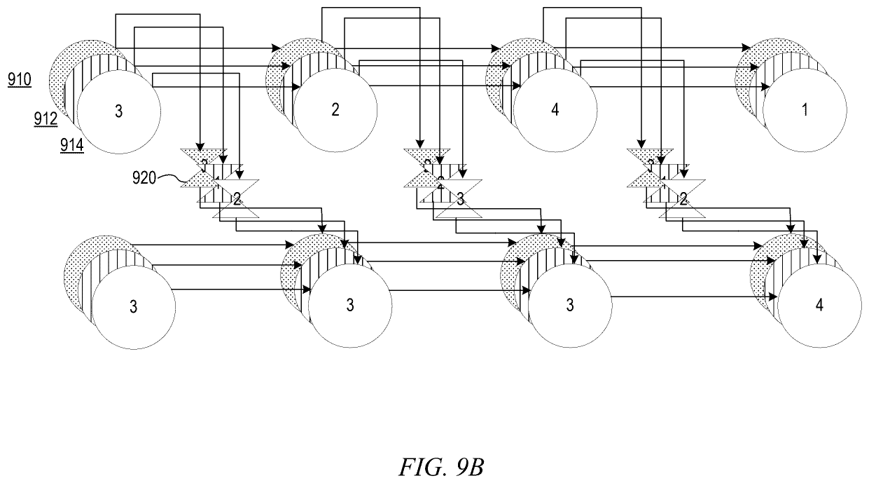

FIGS. 9A and 9B are example diagrams illustrating a shortest path, or lowest latency path, selection using a HE circuit tile tensor shape selection graph in accordance with one illustrative embodiment. FIG. 9A illustrates the representation of an HE circuit comprising four sub-circuits or slices for various types of tile tensor shapes, and for transitions or reshaping operations to transition from one tile tensor shape to another for subsequent sub-circuits or slices of the HE circuit. FIG. 9B illustrates a similar representation but as a nodal graph with nodes representing sub-circuits or slices and edges representing transitions from one tile tensor shape to another for the various sub-circuits or slices.

In the depicted example, assuming that the performance metric is latency, the simulations may determine a compute time or latency for each type of sub-circuit or slice, and for each number of available devices and each possible tile tensor shape in a set of possible tile tensor shapes and store that information for later retrieval, such as in the simulation lookup data structures 814. In the example shown in FIG. 9A, each set of planes 910, 912, and 914 corresponds to a different tile tensor shape, e.g., shapes 1, 2, and 3, with the same HE circuit having four sub-circuits or slices shown in each set of planes 910, 912, and 914. Each set of planes 910, 912, and 914 has a separate plane for each possible number of devices available for parallel execution of the HE circuit, e.g., CPU only, 1 GPU, 2 GPUs, etc. It should be appreciated that the sub-circuits or slices are shown as basic Boolean circuits for illustration purposes only, as the HE algorithms are modeled using a circuit model representation due to the HE computations being agnostic to the inputs, similar to a circuit. These are not intended to depict actual HE computations or HE sub-circuits or slices of an HE circuit.

As further illustrated in FIG. 9A, the transitions between various tile tensor shapes 1, 2, and 3 of the sets of planes 910, 912, and 914 are represented as gates 920 between the sets of planes 910, 912, and 914, where these gates are reshape operations for reshaping or moving data from one data structure having a first tile tensor shape to a second data structure having a second tile tensor shape. These gates may be provided between each possible pairing of tile tensor shapes.

The latencies of each of the individual sub-circuits or slices themselves, as well as any possible reshaping operations to move from one tile tensor shape to another, may be aggregated to generate a total latency or compute time for the circuit given the specific selection of tile tensor shapes and reshaping operations. A shortest path, e.g., lowest latency path, may then be selected from these various options of tile tensor shapes, which may involve different tile tensor shapes for different sub-circuits or slices and different reshaping operations when transitioning from one tile tensor shape to another. The shortest path, or lowest latency path, in the depicted example is represented as the shaded sub-circuits/slices in the sets of planes 910, 912, and 914. It should be appreciated that this shortest path, or lowest latency path, may be different depending on the number of available devices, and thus, may change over time as the runtime environment's dynamic conditions change.

As shown in FIG. 9B, the circuit representation in FIG. 9A may likewise be represented as a graph representation, such as HE circuit tile tensor shape selection graph 818 in FIG. 8, in which nodes represent the different sub-circuits/slices, different nodes in the same plane may represent different numbers of devices available, and edges that represent intermediate tile tensors with reshape operation nodes that represent reshape operations for transitioning from one tile tensor shape to another for the sub-circuits/slices. Edges in the same plane represent the same tile tensor shape being used for subsequent sub-circuits/slices. Edges between planes represent a transition, or reshaping, from one tile tensor shape to another, and have gates representing the reshaping operation. Each of the nodes and the reshaping gates have associated numerical values representing a performance metric (example numerals are provided just for illustration purposes). A shortest path is one having a smallest total numerical value for the sum of values along the path, e.g., a lowest latency in this example. This evaluation may be performed along each possible path from one node to the next along the HE circuit (from left to right in this depicted example). Thus, using such a nodal graph representation, such as HE circuit tile tensor shape selection graph 818, either through dynamic simulation by the simulator 812, or through a lookup of previously generated performance information from previous simulations of sub-circuits/slices for various tile tensor shapes and numbers of devices from the simulation lookup data structures 814, an optimal set of tile tensor shapes and reshape operations may be selected for implementing the HE computations for the next one or more sub-circuits/slices of the HE circuit both during the static analysis of the offline phase and the dynamic analysis of the online or runtime phase.

Again, with reference to FIG. 8, it should be appreciated that the offline phase of operation does not require that the simulation be performed ahead of time and results stored in the simulation lookup data structures 814, as this is only one possible embodiment. To the contrary, in other illustrative embodiments, the simulations may be performed with regard to the specific sub-circuits or slices of the given HE circuit 842 in response to receiving or generating the HE circuit 842 for execution during runtime on provided ciphertext data workloads. That is, rather than performing a lookup operation in the simulation lookup data structures 814, the offline phase mechanisms of the illustrative embodiments may execute the simulation of each sub-circuit or slice by the sub-circuit simulator 812 and generate the predicted performance results given variations in tile tensor shape and available devices. A highest performing, e.g., lowest latency, path of tile tensor shapes and reshape operations may then be selected for use in executing the HE circuit 842, such as in the manner described above with reference to FIGS. 9A and 9B.

Again, it should be appreciated that this simulation may be performed with regard to a subset of the sub-circuits or slices, e.g., the first slice or first few slices, or for the entire HE circuit 842. This may result in different tile tensor shapes being selected for difference slices or sub-circuits of the HE circuit 842, as shown in the example of FIGS. 9A and 9B, for example, and thus may require the application of tile tensor reshape operations between the slices to more efficiently perform HE packing in the tile tensors. This is to facilitate more efficient HE packing such that the tile tensor can be split between the available devices efficiently and in as much of a balanced manner as possible. The selection based on the static analysis may be limited to only the particular number of devices predicted to be available to execute the HE circuit 842.

Thus, for example, in some illustrative embodiments, the offline circuit optimizer 810 receives an application, i.e., HE circuit 842, or generates, by the circuit generation engine 840, an HE circuit 842 based on a specification in a request from the user computing system 870, which is to be used to execute an HE operation in the HE system 830. The offline circuit optimizer 810 may also receive a list of possible devices that may be used to execute the HE circuit 842 in a SIMD or parallel manner, such as from the user profiles 848, and a map to break the application into slices. FIG. 9A shows an example map of the HE circuit into sub-circuits/slices, e.g., the four sub-circuits/slices depicted in FIG. 9A. The offline circuit optimizer 810 of the illustrative embodiments executes either by brute-forcing all the different shapes or by selecting only some of them for simulation and evaluation. For every tile tensor shape selected for evaluation, the offline circuit optimizer 810 simulates or computes the runtime performance under different device availability configurations, e.g., 1, 2, 3, 4, etc. devices available, or alternatively, the offline circuit optimizer 810 may compute the level of parallelization of a slice, i.e., the least amount of data movement between devices if X devices exist. For each sub-circuit or slice, the number of sub-circuit or slice simulations and evaluations is the number of devices (# devices) multiplied by the number of shapes (# shapes), i.e., # devices×# shapes. Thus, in some cases, these simulations may be performed ahead of time and stored in the simulation lookup data structures 814 so that an approximate performance for a given HE circuit 842 may be determined from retrieval of the stored simulation results for given sub-circuits or slices of the HE circuit 842, number of available devices, and possible tile tensor shapes, rather than having to execute the actual simulation again. The result is an initial recommendation of tile tensor shapes to utilize for one or more of the sub-circuits or slices of the HE circuit 842, e.g., at last the first sub-circuit or slice of the HE circuit 842.

Subsequently, in an online phase, the illustrative embodiments may implement the dynamic tile tensor shape optimizer 822 of a circuit evaluation layer, e.g., CircLayer 820, to dynamically determine the device availability status and dynamically analyze the HE circuit 842 for various combinations of tile tensor shapes and device availability. For example, the dynamic tile tensor shape optimizer 822 may again utilize a nodal graph representation, e.g., HE circuit tile tensor shape selection graph 818, of the HE circuit 842 as shown in FIG. 9B, for example, but with limitations to the particular number of available devices that are actually available given the current runtime conditions of the runtime environment. For example, if only 1 GPU is currently available for execution of the HE circuit 842, then the simulation results for 2 GPUs is not considered since the runtime environment cannot currently provide 2 GPUs to execute the HE circuit 842, or remainder of the HE circuit 842. Thus, tile tensor shapes that represent the shortest path, e.g., lowest latency, for only the planes in each set of planes 910, 912, and 914 that correspond to the current possible availability of numbers of devices may be evaluated.

The dynamic tile tensor shape optimizer 822 may then dynamically adapt the tile tensor shapes and perform reshape operations to achieve an optimized execution of the HE circuit 842 based on runtime conditions. In some cases, this may involve performing lookup operations in the simulation lookup data structures 814, or executing runtime simulations, for the next Y number of slices or sub-circuits in the HE circuit 842 for various tile tensor shapes and a current number of available devices, as determined dynamically by the CircLayer 820 and stored in the runtime environment data 816. This may again take into consideration the performance impact of inserting reshape operations to transition from one tile tensor shape to another. Thus, similar to the offline phase of operation executed by the offline circuit optimizer 810, during the runtime or online phase of operation, the dynamic tile tensor shape optimizer may perform the selection of tile tensor shapes for subsequent sub-circuits or slices using simulations and/or previously stored simulation results represented in a HE circuit tile tensor shape selection graph 818, but instead with a runtime knowledge of the available devices to perform parallel execution by splitting the tile tensor across the available devices.

It should again be appreciated that, with the illustrative embodiments, instead of considering just one potential (optimized) circuit, which is the result of an HE circuit optimizer's fixed selection of a tile tensor shape, the improved computing tool and improved computing tool operations/functionality evaluate a complex combination of multiple possible tile tensor shapes, multiple possible available devices, and different sub-circuits or slices of an HE circuit. These options may be represented as a multi-dimensional circuit, e.g., as shown in FIG. 9A, where in every surface (x, y axes) there is an HE circuit 842 corresponding to a given tile tensor shape. In an example of a three-dimensional circuit implementation, the z-axis defines the different evaluated tile tensor shapes, e.g., planes 910, 912, and 914, the x axis representing different slices or sub-circuits of the HE circuit, and the y axis representing different numbers of available devices, e.g., CPU, 1 GPU, 2 GPUs, etc. At every slice border along the x-axis in this three-dimensional circuit, there is an option “to move” between x-y surfaces by executing a reshape operation, e.g., gates 920 in FIG. 9A. The sub-circuits on each x-y surface, per slice, perform the same logical operation, i.e., they have the same inputs/outputs, and just the format of encoding (packing) of the data is different for the different tile tensor shapes.

The dynamic tile tensor shape optimizer 822 of the illustrative embodiments may evaluate this multi-dimensional circuit at various times during execution of the HE circuit 842 in the runtime environment, e.g., at each slice boundary or just prior to a slice boundary, e.g., when a previous HE operation of a previous slice or sub-circuit is X % complete, e.g., 90% complete, to determine whether for a next sub-circuit or slice, or a next predetermined number of sub-circuits/slices, a change in tile tensor shape will result in improved performance, which includes evaluating the overhead of performing the reshape operation itself. That is, in addition to determining the runtime performance under different device availabilities, the dynamic tile tensor shape optimizer 822 also computes the cost of performing a reshape operation between every pair of possible tile tensor shapes. This information is added as a gate 920 between the x-y surfaces 910, 912, and 914 of the multi-dimensional circuit and allows a dynamic tile tensor shape optimizer 822 of the circuit evaluation layer (CircLayer) 820 to dynamically determine what surface (tile tensor shape) to use per slice.

Thus, at the circuit evaluation layer (CircLayer) 820 a multi-dimensional graph (e.g., three-dimensional graph), e.g., HE circuit tile tensor shape selection graph 818, of the multi-dimensional circuit may be utilized by the dynamic tile tensor shape optimizer 822, where the graph has nodes representing corresponding sub-circuits or slices, surfaces representing different tile sensor shapes, and edges representing transitions from one slice to another, which may include gates for reshaping tile tensor shapes. The multi-dimensional graph is evaluated by the dynamic tile tensor shape optimizer 822 of the CircLayer 820 with regard to the recommended first slice(s) tile tensor shape, as determined during the offline phase, according to the available devices determined during the online phase. At every slice border (or some gates before it, e.g., at X % completion of the prior slice) the dynamic tile tensor shape optimizer 822 of the CircLayer 820 tests the available hardware devices and checks which sub-circuit or slice tile tensor shape provides the highest level of parallelization (e.g., lowest latency, lowest number of data movements between devices, or the like) within the next Y number of slices, where Y may be any value suitable to the particular implementation, e.g., Y=1, 2, 3, etc. The dynamic tile tensor shape optimizer 822 also takes into account the expected performance cost, e.g., latency, memory usage, or the like, of reshaping the data to move to a new tile tensor shape from a previous tile tensor shape. The dynamic tile tensor shape optimizer 822 finds the best solution for a given dynamic situation of the available devices. In some illustrative embodiments, the dynamic tile tensor shape optimizer 822 can attempt to predict the available devices in future slices and dynamically choose the best sub-circuit tile tensor shape to evaluate at a given time.

Based on the offline selection of tile tensor shapes, the HE system 830 is configured to execute the HE computations of the HE circuit 842 using the selected tile tensor shapes for the various subcircuits/slices of the HE circuit 842 and perform the selected reshape operations. This selection may then be updated dynamically, such as when there is a detected change in the runtime environment's resource availability. For example, if initially 3 GPUs are available for execution of the HE circuit 842 in a parallel or SIMD manner, but at a later point in the HE circuit 842 execution, the available resources drops to 2 GPUs, then this may initiate an update of tile tensor shape selections by the dynamic tile tensor shape optimizer 822 using the runtime environment data 816 as determined by the CircLayer 820. Alternatively, such dynamic evaluation may be performed for each sub-circuit/slice, such as at a point in the execution where the current sub-circuit/slice has reach X % completion, so as to determine the optimum tile tensor shape for the next sub-circuit/slice. The homomorphic encryption engine 850 and homomorphic encryption computation engine 860 may execute the HE circuit 842 in accordance with the tile tensor shapes, which may also include the reshaping operations when required.

Thus, the illustrative embodiments provide an improved computing tool and improved computing tool operations/functionality to dynamically determine the optimum tile tensor shape for slices of an application or circuit, e.g., a HE circuit, based on available parallelization capabilities of the available hardware. The illustrative embodiments evaluate a variety of different tile tensor shapes, as well as the performance overhead required for reshaping tile tensors from one tile tensor shape to another, and selects a tile tensor shape for a next sub-circuit or slice based on a determination of an optimized performance given the dynamic conditions of the available hardware devices and parallelization capabilities. Thus, rather than utilize a fixed tile tensor shape, the illustrative embodiments are able to dynamically adapt the tile tensor shape during runtime execution of an application or circuit, e.g., HE circuit, based on the dynamically changing conditions of available hardware devices for performing parallel, e.g., SIMD, execution of compute operations on data elements, such as ciphertexts of HE operations of an HE circuit. This improves the performance of HE operations and HE circuits by reducing latency, memory usage, throughput, and communication costs.

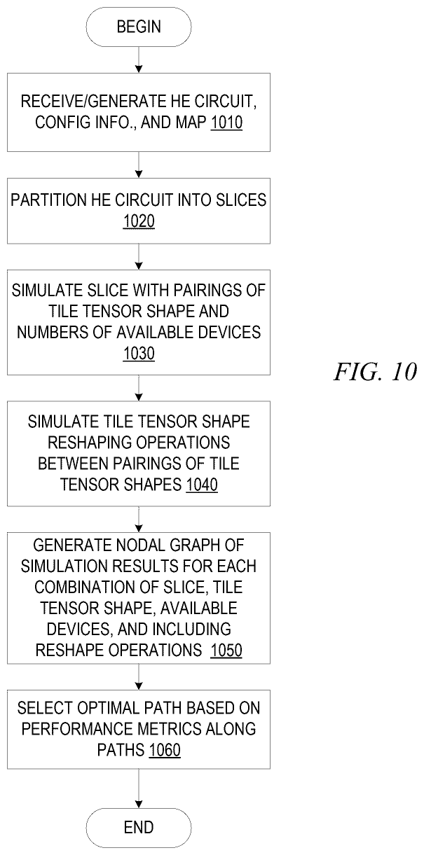

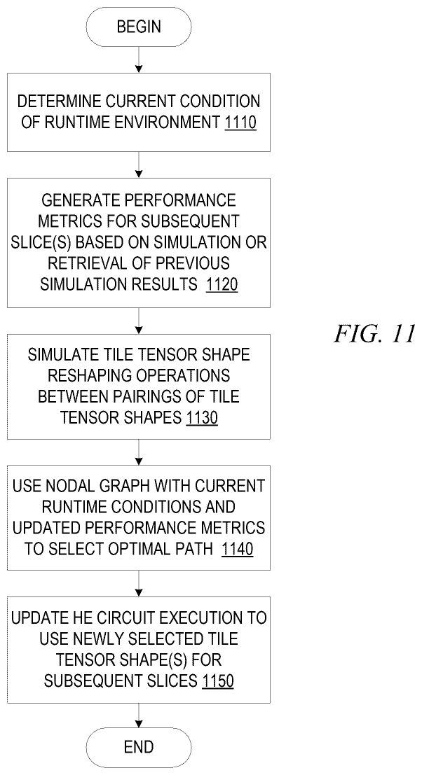

FIGS. 10-11 present flowcharts outlining example operations of elements of the present invention with regard to one or more illustrative embodiments. It should be appreciated that the operations outlined in FIGS. 10-11 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 10-11, and may, in some cases, make use of the results generated as a consequence of the operations set forth in FIGS. 10-11, the operations in FIGS. 10-11 themselves are specifically performed by the improved computing tool in an automated manner.

FIG. 10 is a flowchart outlining an example offline operation of a VTTS system in accordance with one illustrative embodiment. As shown in FIG. 10, the operation starts by receiving/generating a HE circuit to be used to execute workloads of ciphertexts, configuration information specifying tile tensor shapes to evaluate and numbers of devices that may be used to execute the HE circuit in parallel, and a map for partitioning the HE circuit into sub-circuits/slices (step 1010). The HE circuit is partitioned into sub-circuits/slices (step 1020) and each sub-circuit/slice is simulated with regard to various pairings of tile tensor shape and numbers of available devices to simulate performance and generate performance metrics for each pairing for each sub-circuit/slice (step 1030). For each pairing of tile tensor shapes in the specified tile tensor shapes, for each sub-circuit/slice border, a performance impact or cost of a reshaping operation is simulated (step 1040). A nodal graph of the HE circuit with performance metrics for each sub-circuit, tile tensor shape, and number of available devices is generated, where the graph also includes edges representing transitions between tile tensor shapes for each sub-circuit/slice, where changes between tile tensor shapes are further represented with nodes or gates representing the reshaping operation (step 1050). A shortest path, or best performance path, is then selected from the graph to thereby select tile tensor shapes for the sub-circuits/slices of the HE circuit (step 1060). The operation then terminates.

FIG. 11 is a flowchart outlining an example runtime or online operation of a VTTS system in accordance with one illustrative embodiment. As shown in FIG. 11, the operation starts by determining a current condition of a runtime environment with regard to an available number of devices to execute an HE circuit (step 1110). For each subsequent sub-circuit/slice, in a configured number of subsequent sub-circuits/slices, e.g., the next X sub-circuits/slices, the subsequent sub-circuit/slice is simulated, or previous simulation results are retrieved, with regard to various pairings of tile tensor shape and the possible available devices given the current runtime conditions, to simulate performance and generate performance metrics for each pairing for each subsequent sub-circuit/slice (step 1120). For each pairing of tile tensor shapes in the specified tile tensor shapes, for each of the subsequent sub-circuit/slice border, a performance impact or cost of a reshaping operation is also simulated (step 1130). The nodal graph of the HE circuit, with the updated performance metrics for each sub-circuit, tile tensor shape, and number of available devices is evaluated to select a shortest path, or best performing path, to thereby select tile tensor shapes for the subsequent sub-circuits/slices of the HE circuit (step 1140). The HE circuit execution is then updated to use the newly selected tile tensor shapes for the subsequent sub-circuits/slices (step 1150). The operation then terminates. While FIG. 11 shows this operation terminating, it should be appreciated that this process may be repeated periodically, at various points during the runtime execution of the HE circuit, e.g., when the execution of the current sub-circuit/slice reaches x %, or the like, to thereby dynamically update the tile tensor shape selection for sub-circuits/slices of the HE circuit.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for parallel execution of an application, the method comprising:
partitioning the application into a plurality of slices, each slice comprising a portion of the application;
for each slice in the plurality of slices, executing a simulation of an execution of the slice with regard to a plurality of pairings of tile tensor shape for input data to the corresponding slice, and number of available devices to execute the slice, to thereby generate a plurality of simulation results, each having at least one performance metric for a corresponding pairing;
selecting a set of one or more tile tensor shapes for one or more slices in the plurality of slices based on one or more simulation results in the plurality of simulation results, wherein the selected tile tensor shape for each corresponding slice is used to pack data for input to the corresponding slice in the one or more slices; and
executing the application using the selected set of one or more tile tensor shapes for the one or more slices.

2. The method of claim 1, wherein the method is executed in an offline phase of operation prior to dynamic execution of the application.

3. The method of claim 1, wherein the method is executed in an online phase of operation after execution of the application is initiated, and wherein executing the application using the selected set of one or more tile tensor shapes comprises continuing execution of the application with the selected set of one or more tile tensor shapes for slices in the plurality of slices that have not already been executed.

4. The method of claim 1, wherein the application is a homomorphic encryption (HE) application represented as a HE circuit, the data is a workload of ciphertexts, and the slices are sub-circuits of the HE circuit.

5. The method of claim 1, wherein selecting a set of one or more tile tensor shapes comprises generating a graph representation data structure of the application in which the graph representation data structure represents the plurality of slices in planes corresponding to different tile tensor shapes, each plane having one or more sub-planes corresponding to numbers of available devices, nodes of each plane corresponding to a slice in the plurality of slices, and edges representing transitions from one tile tensor shape to another.

6. The method of claim 5, wherein selecting the set of one or more tile tensor shapes comprises selecting one or more tile tensor shapes that result in a highest performance path through the graph representation data structure.

7. The method of claim 6, wherein the highest performance path is a path having a lowest latency determined based on the plurality of simulation results.

8. The method of claim 5, wherein the graph representation data structure further comprises one or more reshape operation nodes representing one or more corresponding reshape operations for the transitions from one tile tensor shape to another, wherein the one or more reshape operation nodes comprise performance metric information for performing the one or more corresponding reshape operations.

9. The method of claim 1, wherein the slices in the plurality of slices have a sequential order, and wherein the selecting of the set of one or more tile tensor shapes is performed dynamically after execution of each intermediate slice in the plurality of slices, wherein the set of one or more tile tensor shapes are used to execute at least a next slice in the plurality of slices.

10. The method of claim 1, wherein executing the simulation and selecting the set of one or more tile tensor shapes is performed statically for a first portion of slices in the plurality of slices, and is performed dynamically during execution of the application for a second portion of slices in the plurality of slices.

11. A computer program product comprising a computer readable storage medium having a computer readable program stored therein, wherein the computer readable program, when executed on a computing device, causes the computing device to:
partition the application into a plurality of slices, each slice comprising a portion of the application;
for each slice in the plurality of slices, execute a simulation of an execution of the slice with regard to a plurality of pairings of tile tensor shape for input data to the corresponding slice, and number of available devices to execute the slice, to thereby generate a plurality of simulation results, each having at least one performance metric for a corresponding pairing;
select a set of one or more tile tensor shapes for one or more slices in the plurality of slices based on one or more simulation results in the plurality of simulation results, wherein the selected tile tensor shape for each corresponding slice is used to pack data for input to the corresponding slice in the one or more slices; and
execute the application using the selected set of one or more tile tensor shapes for the one or more slices.

12. The computer program product of claim 11, wherein the computer executable program is executed in an offline phase of operation prior to dynamic execution of the application.

13. The computer program product of claim 11, wherein the computer executable program is executed in an online phase of operation after execution of the application is initiated, and wherein executing the application using the selected set of one or more tile tensor shapes comprises continuing execution of the application with the selected set of one or more tile tensor shapes for slices in the plurality of slices that have not already been executed.

14. The computer program product of claim 11, wherein the application is a homomorphic encryption (HE) application represented as a HE circuit, the data is a workload of ciphertexts, and the slices are sub-circuits of the HE circuit.

15. The computer program product of claim 11, wherein selecting a set of one or more tile tensor shapes comprises generating a graph representation data structure of the application in which the graph representation data structure represents the plurality of slices in planes corresponding to different tile tensor shapes, each plane having one or more sub-planes corresponding to numbers of available devices, nodes of each plane corresponding to a slice in the plurality of slices, and edges representing transitions from one tile tensor shape to another.

16. The computer program product of claim 15, wherein selecting the set of one or more tile tensor shapes comprises selecting one or more tile tensor shapes that result in a highest performance path through the graph representation data structure.

17. The computer program product of claim 15, wherein the graph representation data structure further comprises one or more reshape operation nodes representing one or more corresponding reshape operations for the transitions from one tile tensor shape to another, wherein the one or more reshape operation nodes comprise performance metric information for performing the one or more corresponding reshape operations.

18. The computer program product of claim 11, wherein the slices in the plurality of slices have a sequential order, and wherein selecting the set of one or more tile tensor shapes is performed dynamically after execution of each intermediate slice in the plurality of slices, wherein the set of one or more tile tensor shapes are used to execute at least a next slice in the plurality of slices.

19. The computer program product of claim 11, wherein executing the simulation and selecting the set of one or more tile tensor shapes is performed statically for a first portion of slices in the plurality of slices, and is performed dynamically during execution of the application for a second portion of slices in the plurality of slices.

20. An apparatus comprising:
at least one processor; and
at least one memory coupled to the at least one processor, wherein the at least one memory comprises instructions which, when executed by the at least one processor, cause the at least one processor to:
partition the application into a plurality of slices, each slice comprising a portion of the application;
for each slice in the plurality of slices, execute a simulation of an execution of the slice with regard to a plurality of pairings of tile tensor shape for input data to the corresponding slice, and number of available devices to execute the slice, to thereby generate a plurality of simulation results, each having at least one performance metric for a corresponding pairing;
select a set of one or more tile tensor shapes for one or more slices in the plurality of slices based on one or more simulation results in the plurality of simulation results, wherein the selected tile tensor shape for each corresponding slice is used to pack data for input to the corresponding slice in the one or more slices; and
execute the application using the selected set of one or more tile tensor shapes for the one or more slices.
